(19) United States
(12) Patent Application Publication
(10) Pub. No.: US 2017/0166845 A1
(43) Pub. Date: Jun. 15, 2017

(54) ENCAPSULATED BENEFIT AGENT PARTICLES

(71) Applicant: REVOLYMER (U.K.) LIMITED, Deeside (GB)

(72) Inventors: David John DUNCALF, Deeside (GB); Paul Hugh FINDLAY, Deeside (GB); David Alan PEARS, Deeside (GB); Magdalena Agnieszka WARUNEK, Deeside (GB); Robert Neil HAY, Deeside (GB)

(73) Assignee: REVOLYMER (U.K.) LIMITED, Deeside (GB)

(21) Appl. No.: 15/325,570

(22) PCT Filed: Jul. 13, 2015
(86) PCT No.: PCT/GB2015/052017

§ 371 Date: Jan. 11, 2017

(30) Foreign Application Priority Data
Jul. 11, 2014 (GB) 1412413.5

(51) Int. Cl. C11D 17/00; C11D 11/00; C11D 3/39; C11D 3/37

(52) U.S. Cl. CPC C11D 17/0039; C11D 3/3753; C11D 11/0017; C11D 3/3942

(57) ABSTRACT

A composite including at least one benefit agent, and a blend including: at least one water soluble polymer; and at least one salt, or at least one surfactant, or a mixture thereof; optionally at least one wax or wax-like substance; and optionally at least one amphiphilic polymer. Further aspects of the invention relate to a process for preparing the composites, consumer products including the composites and uses thereof.

### FIELD OF INVENTION

The present invention relates to the encapsulation of benefit agents, where the benefit agent is a reactive, pro-reactive or catalytic entity that requires protection from other formulation ingredients, but which can be released in response to a particular trigger caused by a change in their environment. This invention also relates to processes for making such encapsulates, as well as their use in products with a wide range of applications.

### BACKGROUND TO THE INVENTION

In liquid cleaning products such as laundry detergents, laundry stain boosters, dishwash cleaners and liquid cleaning products chemical incompatibility of certain ingredients may result in negative interactions which can lead to a reduction in the efficacy of such products. The consumer is turning more and more to liquid formulations, particularly liquid laundry and dishwash formulations because of increased convenience and perceived less aggressive action. Whereas in the past solid formats were able to perform this function to a high degree of efficacy this was, in the main, due to the lack of negative interactions between active ingredients because such reactions were not particularly favoured in a solid format as long as the product remained dry. However, in areas of the world where ambient temperatures and humidities are high even solid or powder formats can show significant degradation of the active benefit agents, such as enzymes or percarbonate based bleach, due to these challenging climatic effects.

As mentioned above, the consumer now appreciates the convenience of liquid formulations but is becoming more aware of the limited efficacy of liquid formulations particularly as wash temperatures are becoming lower and hence consumers may be dissatisfied with the performance of liquid formulations especially on stains which require removal by bleach. Bleaches such as sodium percarbonate are routinely added to laundry wash powders and are reasonably effective at elevated temperature on bleaching stains such as tea, coffee and grass, as examples. Sodium percarbonate is, however, particularly sensitive to the presence of even low levels of water and will become degraded if moisture is allowed to permeate the powder. Other bleaches such as 6-phthalimidoperoxyhexanoic acid (PAP), an organic peracid, are also easily degraded by the presence of moisture, especially in the presence of alkaline materials, to yield phthalimidohexanoic acid and hydrogen peroxide. Unfortunately, even in the presence of small quantities of water these degradation reactions can render the laundry powder inactive, from a bleaching point of view, within weeks.

Whilst it is possible to keep reactive agents separately from incompatible ingredients, by for example, engineering physical separation in the product such as producing ‘two-pack’ formats, it has been shown that consumers do not welcome the added complexity of needing to add two components.

One solution to maintaining a separation between several incompatible ingredients is to encapsulate the said ingredients ensuring that the encapsulating coating is an efficient barrier and will prevent interaction between the ingredients. It is important that the coating which protects the active agents is able to remain intact and insoluble whilst within the product as it remains in a stable form ‘on the shelf.’ However, it must dissolve quickly when in use and release the active benefit agent quickly and effectively into the wash.

The coating and encapsulation of detergent components with various inorganic and organic materials have been widely documented in the art. By way of example, WO 94/15010 (The Proctor & Gamble Company) discloses a solid peroxyacid bleach precursor composition in which particles of peroxyacid bleach precursor are coated with a water-soluble acid polymer, defined on the basis that a 1% solution of the polymer has a pH of less than 7.

Likewise, WO 94/03568 (The Proctor & Gamble Company) discloses a granular laundry detergent composition having a bulk density of at least 650 g/L, which comprises discrete particles comprising from 25-60% by weight of anionic surfactant, inorganic perhydrate bleach and a peroxyacid bleach precursor, wherein the peroxyacid bleach precursor is coated with a water soluble acidic polymer.

U.S. Pat. No. 6,225,276 (Henkel Kommanditgesellschaft auf Aktien) discloses a solid particulate detergent composition comprising a coated bleaching agent that dissolves in water irrespective of pH, a bleach activator coated with a polymeric acid that only dissolves at pH values above 8, and an acidifying agent.

WO 98/00515 (The Proctor & Gamble Company) discloses non-aqueous, particulate-containing liquid laundry cleaning compositions which are in the form of a suspension of particulate material comprising peroxygen bleaching agents and coated peroxygen bleach activators. The coating material is soluble in water, but insoluble in non-aqueous liquids, and is selected from water soluble citrates, sulfates, carbonates, silicates, halides and chromates.

U.S. Pat. No. 6,107,266 (Clariant GmbH) discloses a process for producing coated bleach activating granules in which bleach activator base granules are coated with a coating substrate and are simultaneously and/or subsequently thermally conditioned. The coating substance is selected from C₈-C₃₁ fatty acids, C₈-C₃₁ fatty alcohols, polyalkylene glycols, non-ionic surfactants and anionic surfactants.

EP 0846757 (Unilever NV) discusses the problem of incorporating oxygen bleaches into liquid dishwashing formulations. It refers to Unilever U.S. Pat. No. 5,200,236 which describes the coating of water soluble cores with paraffin wax.

U.S. Pat. No. 5,783,540 (Unilever US) discusses the use of paraffin wax (mp 55-70° C.) as a continuous layer coated upon a benefit agent containing core for use in solid powder or tablet dishwashing products in order to provide a rinse benefit.

U.S. Pat. No. 5,837,663 (Unilever) discusses the use of paraffin wax (mp 55-70° C.) as a continuous layer which coats a core containing a peracid. Use in dishwashing solid powder or tablet products is particularly described.

U.S. Pat. No. 5,900,395 (Unilever) discusses the use of paraffin wax (mp 35-50° C.) as a continuous layer which coats a core containing a peracid. Use in dishwashing solid powder or tablet products is particularly described.

EP 0436971 (Unilever) specifically describes the application of a single coating of paraffin wax and describes a core composed of a water-soluble/dispersible bleach material coated with a continuous waxy coating with a melting point of 40-50° C. The document discusses the problems of incorporating actives in aqueous cleaning compositions.

EP 0510761 (Unilever) describes a core composed of a water-soluble/dispersible material coated with a continuous waxy coating with a melting point of 40-50° C. and discusses the problems with incorporating actives in aqueous cleaning compositions. The core may be a bleach, a bleach catalyst, an enzyme, a peracid precursor, a diacylperoxide and a surfactant. The document describes the method of production which is by spray coating using a molten wax in a fluid bed. Applications are primarily for dishwashing products.

WO 95/33817 (Unilever) teaches that dissolution rates, particularly for PAP, from wax encapsulates are often slow. The solution to this problem is to incorporate surfactant into the core. WO 95/33817 also describes the use of a fluid bed to coat cores with molten paraffin wax. Cores may be peroxy acids, diacyl peroxides, peroxygen bleach precursors and mixtures thereof.

WO 95/30735 (Unilever PLC) describes the application of a wax/polyvinyl ether (PVE) coating. The PVE helps to modify the melting behaviour of the coating and improves flowability. Applications include liquid cleaning compositions such as dishwashing, where the particle is stable in alkaline formulation. Cores can include bleaches, both oxygen and chlorine based, or a H₂O₂ generating compound. Cores also include enzymes, proteins and bleach activators. The paraffin melts from between 40-60° C. and coating is achieved by spraying molten wax composition onto the particles.

EP 0596550 and U.S. Pat. No. 5,336,430 (Unilever PLC) describe the use of a structurant to thicken a dishwash formulation. The use of a paraffin wax encapsulated chlorine-based bleach is described.

EP 0533239 (Unilever PLC) describes the problems encountered when a bleach is formulated together with an enzyme in a liquid formulation. The solution to the problem is given by encapsulating the bleach and by incorporating a reducing agent to ‘hold back’ the bleach activity until the enzyme has completed its function. Interestingly it discusses that wax coatings are rendered useless if even a small crack is present in the coating. It describes the application of a single coat of paraffin wax and the encapsulation of a chlorine, bromine or peroxy(acid) bleaches.

U.S. Pat. No. 5,505,875 (Degussa) describes the coating of fine particles of percarbonate with molten wax via a hot ‘fog’ process.

U.S. Pat. No. 7,897,557 (Henkel) utilises a cross-linking reaction to crosslink a polymer coating on a peroxyacid core. Mention is made that the coated particles may further be coated with wax.

WO 2012/140413 (Reckitt Benckiser) discloses a composite core particle which is encapsulated with a pH responsive acrylic polymer and which includes a claim describing a layer of hydrophobic material which can be a wax.

PCT/GB2010/002007 (WO 2011/051681; Revolymer Ltd) describes encapsulation using pH responsive polymers in conjunction with bleach activators.

PCT/GB2012/050819 (WO 2012/140438; Revolymer Ltd) describes a similar technology in conjunction with enzymes and PCT/GB2012/050823 (WO 2012/140442; Revolymer Ltd) describes encapsulation with ionic responsive coating materials.

The present invention seeks to provide composites which contain benefit agent(s) encapsulated within a core, or within a matrix, and to methods for their manufacture, and in particular to liquid detergent formulations and cleaning formulations which may contain such composites.

### STATEMENT OF INVENTION

A first aspect of the invention relates to a composite comprising at least one benefit agent, and a blend comprising:

(i) at least one water soluble polymer; and
(ii) at least one salt, or at least one surfactant, or a mixture thereof;
(iii) optionally at least one wax or wax-like substance; and
(iv) optionally at least one amphiphilic polymer.

Another aspect of the invention relates to a composite comprising:
(a) one or more core units (A) comprising at least one benefit agent; and
(b) a coating layer (B) on said one or more core units, wherein said coating layer (B) comprises a blend comprising:
   (i) at least one water soluble polymer; and
   (ii) at least one salt, or at least one surfactant, or a mixture thereof;
(c) optionally a further coating layer (C) comprising a blend comprising:
   (i) at least one wax or wax-like substance; and
   (ii) at least one amphiphilic polymer.

Another aspect of the present invention relates to a composite comprising at least one benefit agent, and a blend comprising:

(i) a water-soluble polymer being a poly(vinyl alcohol) polymer modified by reaction with a 2-10C aldehyde, such that 1-15% of the available —OH groups have been modified;
(ii) at least one ionic species;
(iii) optionally at least one wax or wax-like substance; and
(iv) optionally at least one amphiphilic polymer.

Another aspect of the invention relates to a composite comprising:
(a) one or more core units (A) comprising at least one benefit agent; and
(b) a coating layer (B) on said one or more core units, wherein said coating layer (B) comprises a blend comprising:
   (i) a water-soluble polymer being a poly(vinyl alcohol) polymer modified by reaction with a 2-10C aldehyde, such that 1-15% of the available —OH groups have been modified; and
   (ii) at least one ionic species;
(c) optionally a further coating layer (C) comprising a blend comprising:
   (i) at least one wax or wax-like substance; and
   (ii) at least one amphiphilic polymer.

Another aspect of the invention relates to a process for preparing a composite as described herein, said process comprising the steps of:
(1) preparing one or more core units comprising at least one benefit agent;
(2) preparing a coating layer (B) comprising a blend comprising:
   (i) at least one water soluble polymer; and
   (ii) at least one salt, or at least one surfactant, or a mixture thereof;
(3) optionally preparing a further coating layer (C) comprising a blend comprising:
   (i) at least one wax or wax-like substance; and
   (ii) at least one amphiphilic polymer; and
(4) applying coating layer (B) and optionally applying coating layer (C) to the core units to form a composite.

Another aspect of the invention relates to a process for the preparation of a composite as defined herein, said process comprising the steps of:

a) preparing one or more core units comprising at least one benefit agent;
b) contacting the core units with a solution of a blend as defined herein; and
c) drying the resulting particles to yield the composite

Another aspect of the invention relates to a process for preparing a composite as described herein, said process comprising the steps of:

(1) preparing one or more core units comprising at least one benefit agent;
(2) preparing a coating layer (B) comprising a blend comprising:
(i) a water-soluble polymer being a poly(vinyl alcohol) polymer modified by reaction with a 2-10C aldehyde, such that 1-15% of the available —OH groups have been modified; and
(ii) at least one ionic species;
   (3) optionally preparing a further coating layer (C) comprising a blend comprising:
(i) at least one wax or wax-like substance; and
(ii) at least one amphiphilic polymer;
   (4) applying coating layer (B) and optionally applying coating layer (C) to the core units to form a composite; and
   (5) drying the resulting particles to yield the composite.

Another aspect of the invention relates to a consumer product comprising a composite as described above.

Another aspect of the invention relates to the use of a composite or process as described above in the preparation of a consumer product.

Another aspect of the invention relates to a method of preparing a consumer product, such as a laundry product, said method comprising admixing a composite according to the invention with one or more conventional consumer product components.

Another aspect of the invention relates to the use of a composite as described above as an additive in a laundry product. The laundry product is in liquid or gel format, either as a bulk liquid/gel or in a unit dose format, or may be in a solid powder, tablet or granular format.

Another aspect of the invention relates to the use of a blend comprising:

(i) at least one water soluble polymer; and
(ii) at least one salt, or at least one surfactant, or a mixture thereof; as a phlegmatizer.

Another aspect of the invention relates to the use of a blend comprising:

(i) a water-soluble polymer being a poly(vinyl alcohol) polymer modified by reaction with a 2-10C aldehyde, such that 1-15% of the available —OH groups have been modified; and
(ii) at least one ionic species
as a phlegmatizer

Another aspect of the invention relates to the use of a blend comprising:

(i) at least one water soluble polymer; and
(ii) at least one salt, or at least one surfactant, or a mixture thereof;
to stabilise or desensitise a benefit against undesired overheating.

Another aspect of the invention relates to the use of a blend comprising:

(i) a water-soluble polymer being a poly(vinyl alcohol) polymer modified by reaction with a 2-10C aldehyde, such that 1-15% of the available —OH groups have been modified; and
(ii) at least one ionic species
to stabilise or desensitise a benefit agent against undesired overheating.

Advantageously, where the composite of the invention is in the form of a coated core, it allows the encapsulated benefit agent to be released under selective conditions. This is achieved by coating or encapsulating the benefit agents, or aggregates of benefit agents, with materials so as to provide (i) a block to the ingress of water or aqueous solutions by virtue of a polymeric coating layer or layers and, optionally, (ii) a further layer or layers which provide additional protection for the initial layer or layers against attack by formulation ingredients. The characteristics of the materials, polymer or polymers employed in the coating layers is such that a stimuli response is possible wherein the coating provided by the materials, polymer or polymers, will dissolve or disperse in response to stimuli events such as, for example, upon dilution (for example, an increase in water content or a decrease in surfactant concentration), a change in pH, ionic strength or temperature in order to release the benefit agent contained and encapsulated within the core.

### DESCRIPTION OF INVENTION

As used herein, the term “solid” includes granular, powder, bar and tablet product forms. As used herein, the term “fluid” includes liquid, gel, paste and gas product forms.

In the context of the invention, the term “polymer” may be used to indicate a polymer or copolymer containing one or more monomer constituents which may be randomly arranged within the polymer, or may exist in domains such as is the case for block copolymers, or may exist as branched chains which are arranged in a pendant fashion, or a polymer consisting of monomer units which alternate along the polymer backbone, or a polymer whose architecture is a mixture of two or more of the compositions detailed above.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

As described earlier, the problem of providing a shelf-stable liquid detergent formulation which contains an active benefit agent, such as a bleach for example, still remains. In addition the problem of providing a stable solid, or powder, detergent formulation wherein the active benefit agents, such as bleach, for use within challenging climatic conditions such as in hot and humid areas also remains. The subject of this invention is the discovery of a composite material comprising a water soluble polymer, a salt and/or a surfactant and optionally a wax/polymer composite layer which provides for enhanced stability of active benefit agents both in solid and liquid detergent formulations and provides for protection of the active benefit agents against the negative interactions of the other necessary ingredients which are present in both liquid and solid detergent formulations.

A particularly preferred embodiment of the invention relates to a composite comprising one or more core units comprising at least one benefit agent (e.g. a bleach), and a coating, wherein said coating comprises a blend comprising at least one water soluble polymer, at least one salt, and optionally at least one surfactant, and optionally a further wax/polymer composite layer.

Another particularly preferred embodiment of the invention relates to a composite comprising one or more core units comprising at least one benefit agent (e.g. a bleach), and a coating, wherein said coating comprises a blend comprising at least one water soluble polymer, at least one surfactant, optionally at least one salt, and optionally a further wax/polymer composite layer.

Yet another particularly preferred embodiment of the invention relates to a composite comprising one or more core units comprising at least one benefit agent (e.g. a bleach), and a coating, wherein said coating comprises a blend comprising at least one water soluble polymer, at least one salt, at least one surfactant, and optionally a further wax/polymer composite layer.

Still yet another preferred embodiment of the invention relates to a composite comprising at least one benefit agent, and a blend comprising:

(i) at least one water soluble polymer; and
(ii) at least one salt, or at least one surfactant, or a mixture thereof;
(iii) optionally at least one wax or wax-like substance; and
(iv) optionally at least one amphiphilic polymer.

In one preferred embodiment, the composite is in the form of a matrix particle.

For this embodiment, the matrix particle is optionally coated by a blend comprising:

(i) at least one water soluble polymer; and
(ii) at least one salt, or at least one surfactant, or a mixture thereof.

The matrix particle is optionally further coated by a coating layer (C) comprising a blend comprising:

(i) at least one wax or wax-like substance; and
(ii) at least one amphiphilic polymer.

Ionic Species

The ionic species may be a salt or an ionic surfactant (cationic or anionic). It will be understood that for those embodiments presented herein that comprise a particular salt or ionic surfactant, other salts or ionic surfactants may be equally applicable.

It will also be understood that the ionic species is not the water-soluble polymer component of the composite defined herein.

Exemplary ionic species are discussed herein under the headings “SALTS” and “SURFACTANTS” (to the extent that they are ionic).

In a particular embodiment, the ionic species is selected from:
i) chloride, sulphate and carbonate salts of the alkaline metals or alkaline earth metals; and
ii) surfactants represented by the general formula. RSO₃M wherein R represents a hydrocarbon group selected from the group consisting of straight or branched alkyl radicals containing from about 8 to about 24 carbon atoms and alkyl phenyl radicals containing from about 9 to about 15 carbon atoms in the alkyl group; and M is a cation which typically is selected from the group consisting of sodium, potassium, ammonium, monoalkanolammonium, dialkanolammonium, trialkanolammonium, and magnesium cations and mixtures thereof. An exemplary surfactant is sodium dodecyl benzene sulfonate (SDBS).

In another particular embodiment, the ionic species is sodium sulphate or SDBS.

The quantity of the ionic species used as part of the present invention will vary depending on the particular ionic species and the particular water-soluble polymer used. However, it will be understood from the following paragraphs that the quantity of ionic species useful as part of the present invention will be readily apparent to one of ordinary skill in the art.

Irrespective of which ionic species and water-soluble polymer is used, the minimum quantity of ionic species is that which prevents or minimises the dissolution of the water-soluble polymer in a liquid detergent formulation containing 30 wt % or less (preferably 20 wt % of less, more preferably 10 wt % or less) of water. Hence, the minimum quantity of ionic species used as part of the composite is that which results in substantially no release of benefit agent from the composite when the composite is placed in liquid detergent formulations containing 30 wt % or less of water (preferably 20 wt % of less, more preferably 10 wt % or less). To prevent the release of the benefit agent, the skilled person will appreciate that it is necessary to maintain the ionic strength sufficiently high in order that the water-soluble polymer is not dissolved in liquid detergent formulations containing 10 wt % or less of water (preferably 20 wt % of less, more preferably 10 wt % or less). Conversely, when the composite is exposed to a larger body of water (e.g. during a washing cycle), the ionic strength falls markedly and the water soluble polymer is dissolved, thereby releasing the benefit agent.

Increased quantities of ionic species (i.e. greater than the minimum quantity) may also be used.

In a particular embodiment, when a PVOH-based water-soluble polymer modified with 2-10C aldehyde groups is used, the quantity of ionic species is 1% to 95% of the total weight of the coating (blend). Suitably, the quantity of ionic species is 15% to 75% of the total weight of the coating (blend). More suitably, quantity of ionic species is 30% to 60% of the total weight of the coating (blend).

In another particular embodiment, when a PVOH-based water-soluble polymer modified with 2-10C aldehyde groups is used, the quantity of ionic species is 1% to 55% of the total weight of the coating (blend). Suitably, the quantity of ionic species is 5% to 55% of the total weight of the coating (blend). More suitably, the quantity of ionic species is 10% to 55% of the total weight of the coating (blend). Even more suitably, the quantity of ionic species is 15% to 55% of the total weight of the coating (blend). Most suitably, the quantity of ionic species is 30% to 55% of the total weight of the coating (blend).

Salts

In one preferred embodiment of the invention, the composite comprises a coating layer (B) which comprises a blend of a water soluble polymer and a salt.

In another preferred embodiment, the composite comprises a coating layer (B) which comprises a blend comprising at least one water soluble polymer, at least one salt and at least one surfactant.

Preferably, the salt is an inorganic salt. Suitable inorganic salts for use in the composites of the invention include, but are not limited to, halide, silicate, sulfate, citrates, carbonates, phosphates of the alkali or alkali earth metals or ammonium/alkyl ammonium salt forming cations. One or more of these salts may be present to act as fillers or bulking agents or density modifiers but also to act as de-tackifiers during the coating process so as to remove or reduce the tendency of the particles to coalesce together as the coating layer is applied whilst the layer is wet and tacky.

In one highly preferred embodiment of the invention the salt is a chloride salt, more preferably, sodium chloride.

In another highly preferred embodiment the salt is magnesium sulfate, sodium sulfate, or aluminium sulphate.

Preferably, the coating layer (B) is prepared from a solution of the salt and the water soluble polymer. Preferably, the salt is present in a concentration of from about 0.0001 Molar to about 1 M, more preferably from about 0.001 M to about 0.5 M. The solution concentration is highly dependent on the charge of the salt and the solubility of the polymer in the salt solution. NaCl (being 1+ charge can have a higher concentration before the polymer precipitates out) MgSO4 (divalent) can only be present at a very much lower concentration before the polymer precipitates out)

In one highly preferred embodiment of the invention, the salt is present in an amount of from about 1% to about 95% based on the weight of the total coating, more preferably from about 15% to about 75%, even more preferably from about 30% to about 60%%.

Surfactants

In one preferred embodiment of the invention, the composite comprises a coating layer (B) which comprises a blend comprising a water soluble polymer and a surfactant.

In another preferred embodiment, the composite comprises a coating layer (B) which comprises a blend comprising at least one water soluble polymer, at least one surfactant and at least one salt.

Suitable surfactants for use in the composites of the invention include, but are not limited to, various anionic surfactants, especially the alkyl benzene sulfonates, alkyl sulfates, alkyl alkoxy sulfates and various nonionic surfactants, such as alkyl ethoxylates and alkylphenol ethoxylates.

Preferred surfactants may be represented by the general formula RSO₃M wherein R represents a hydrocarbon group selected from the group consisting of straight or branched alkyl radicals containing from about 8 to about 24 carbon atoms and alkyl phenyl radicals containing from about 9 to about 15 carbon atoms in the alkyl group. M is a cation which typically is selected from the group consisting of sodium, potassium, ammonium, monoalkanolammonium, dialkanolammonium, trialkanolammonium, and magnesium cations and mixtures thereof.

Preferred anionic surfactants include the water-soluble salts of alkylbenzene sulfonic acid containing from about 9 to about 15 carbon atoms in the alkyl group and water-soluble alkyl sulfates containing from about 10 to about 18 carbon atoms. Also preferred surfactants can include the water-soluble salt of an alkyl polyethoxylate ether sulfate wherein the alkyl group contains from about 8 to about 24, preferably from about 10 to about 18 carbon atoms and there are from about 1 to about 20, preferably from about 1 to about 12 ethoxy groups. Other suitable anionic surfactants are disclosed in U.S. Pat. No. 4,170,565, Fiesher et al, issued Oct. 9, 1979, incorporated herein by reference. One or more of these surfactants may be present in the layer to act as fillers or bulking agents or density modifiers but also to act as de-tackifiers during the coating process so as to remove or reduce the tendency of the particles to coalesce together as the coating layer is applied whilst the layer is wet and tacky.

In one especially preferred embodiment, the surfactant is sodium dodecylbenzene sulfonate (SDBS), sodium dodecyl sulfonate or sodium laureth sulphate.

In one highly preferred embodiment of the invention, the coating comprises a surfactant, preferably an anionic surfactant, and wherein the surfactant is present in an amount of from about 1 to about 60% based on the weight of the total coating, more preferably from about 1 to about 50%, even more preferably from about 1 to about 20%, even more preferably still from about 1 to about 10% based on the weight of the total coating.

In one preferred embodiment, coating layer (B) is prepared using a surfactant concentration of from about 0.01 M to about 1.0 M, more preferably, from about 0.1 to about 0.25 M.

Water Soluble Polymer

The composites of the invention comprise a coating layer comprising a blend of a water soluble polymer and either a surfactant or salt, or a mixture of a salt and a surfactant.

The term ‘water-soluble polymer’ used herein refers to a polymer which at a particular concentration is totally water-soluble but can also include polymers which are essentially water-soluble but which also contain material(s) which are not water-soluble; such non-soluble materials may become water-soluble at higher dilutions, or at increased temperature or in response to a change in pH or ionic strength (as non-limiting examples), or such materials may be inherently non-soluble and may be present as fillers, for example.

In one preferred embodiment of the invention, the water soluble polymer is a poly(vinyl alcohol) (PVOH) or PVOH-based polymer. Most typically PVOH polymers are manufactured by the polymerisation of vinyl acetate to obtain poly(vinyl acetate) (PVAc). Thereafter the PVAc is hydrolysed to poly(vinyl alcohol), as follows:

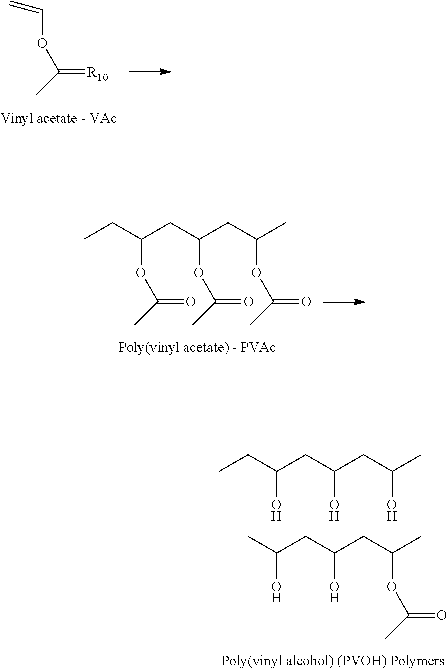

It will be appreciated that during hydrolysis of the PVAc, a number of the vinyl acetate groups present may remain unhydrolysed in the resulting polymer. Such polymers with a mixture of vinyl alcohol units and unreacted vinyl acetate units are also referred to by the name PVOH by those skilled in the art. As is well known in the art the degree of hydrolysis of a PVOH is important in determining its properties.

Optionally, a second monomer such as ethylene may be copolymerised with the vinyl acetate and the resulting copolymers hydrolysed to create vinyl alcohol groups in the same manner. The resulting poly(vinyl alcohol) polymers typically have modified water solubility and other physical properties compared with those derived from homopolymers of vinyl acetate.

It will be appreciated that PVOH may also be prepared by the hydrolysis of other poly(vinyl esters) such as poly(vinyl formate), poly(vinyl benzoate) or poly(vinyl ethers). Similarly a copolymer of vinyl alcohol such as poly(ethylene-vinyl alcohol) may also be prepared by copolymerising the relevant monomer with a vinyl ester other than vinyl alcohol and hydrolysing the resulting polymer for instance. Such polymers are also within the scope of the present invention.

Poly(vinyl alcohol) (PVA) grades with varying degrees of polymerization and hydrolysis are available under the tradename Mowiol (Kuraray Chemicals) and include partly and fully saponified grades. Specific examples of fully saponified Mowiol include those known as 4-98, 6-98, 10-98, 20-98, 15-98, 15-99, 28-99, 30-98 (CAS No: 9002-89-5). Specific examples of partly saponified Mowiol include those known as 3-85 G4, 4-88 G2, 8-88 G2, 18-88 G2, 23-88 G2, 47-88 G2, 3-85, 4-88, 5-88, 8-88, 13-88, 18-88, 23-88, 26-88, 32-88, 40-88, 44-88, 47-88, 30-92, 4-88 LA, 8-88 LA and 40-88 LA (CAS No: 23213-24-5). The first number in the nomenclature denotes the viscosity of the 4% aqueous solution at 20° C. as a relative measure for the molar mass of the Mowiol; the second number denotes the degree of hydrolysis of the polyvinyl acetate from which the Mowiol grade is derived. Mowiol 4-98 and 10-98 are particularly preferred.

In general, preferred PVOH or PVOH-based polymers which are suitable in this application have high levels of hydrolysis within the range 60-99%. Most preferred hydrolysis levels are between 88-99% as these polymers have suitable water solubility characteristics. PVOH or PVOH based polymers which are preferred in this application have average molecular weights ranging from 1,000 Da to 300,000 Da which provide for aqueous solutions which are easily handled. The PVOH may be a copolymer containing polyvinyl acetate monomers at varying degrees according to the degree of hydrolysis of the PVOH. In addition it may be envisioned that a PVOH based polymer may conceivably contain ‘PVOH’ as a block within another polymer or copolymer or as grafts to, or from, another polymer or copolymer backbone or as a branched polymer containing short, oligomeric or polymeric cross-links within the polymeric or co-polymeric structure as a whole. A degree of cross linking may be beneficial in order to maintain structural integrity of the coated layer as well as to increase the barrier properties of the layer. Cross-linking may be carried out by any suitable technique which are well known and may include the use of agents such as epoxides, formaldehydes, isocyanates, reactive siloxanes, anhydrides, amidoamines, boric acid and suitably reactive transition metals and derivatives thereof.

In another preferred embodiment, the water soluble polymer comprises a homopolymer or copolymer of vinyl alcohol. In one preferred embodiment, the water soluble polymer is a polymer containing a vinyl alcohol repeat unit formed via post polymerisation partial hydrolysis of a vinyl ester (such as vinyl acetate) and at least one other monomer. Preferably, the at least one other monomer contains an alkene group (i.e. carbon-to-carbon double bond) capable of undergoing copolymerisation with vinyl alcohol or a suitable precursor monomer such as a vinyl ester.

In one highly preferred embodiment, the water soluble polymer comprises a copolymer of vinyl alcohol and an olefin, such as ethylene or propylene, preferably ethylene. More preferably, the olefin is present in an amount from about 1 to about 50 mol %, such as from about 2 to about 40 mol %, and most preferably from about 5 to about 20 mol % of the polymer backbone.

In another highly preferred embodiment, the water soluble polymer comprises a copolymer of vinyl alcohol formed from a copolymer of vinyl alcohol and an alkene-containing monomer, such as a vinylic (e.g. acrylic) or methacrylic monomer. Examples of suitable alkene-containing monomers which may be used in the present invention include, but are not limited to, styrene, acrylonitrile, methacrylonitrile, crotononitrile, vinyl halides, vinylidene halides, (meth)acrylamide, N,N-dimethyl acrylamide, vinyl polyethers of ethylene or propylene oxide, vinyl esters such as vinyl formate, vinyl benzoate or vinyl ethers (such as VeoVa™ 10 available from Momentive™), vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl (meth)acrylate, 2-hydroxy propyl (meth)acrylate, glycerol mono(meth)acrylate, 4-hydroxy butyl (meth)acrylate, hydroxyl stearyl methacrylate, N-methylol (meth)acrylamide; vinyl monomers with additional functionality for crosslinking or adhesion promotion or post functionalization of the vinyl polymers, such as diacetone acrylamide, aceto acetoxy ethyl (meth)acrylate, glycidyl methacrylate, 2-acrylamido-2-methylpropane sulfonic acid, (meth)acrylic acid, beta carboxy ethyl (meth)acrylate, maleic anhydride, styrene sulfonic acid, sodium sulfo propyl methacrylate, itaconic acid; N,N-dimethyl ethyl amino (meth)acrylate, N,N-diethyl ethyl amino (meth)acrylate, N,N-dimethyl ethyl amino (meth)acrylate, N,N-dimethyl propyl amino (meth)acrylate, N,N-diethyl propyl amino (meth)acrylate, vinyl pyridine, amino methyl styrene, crotonic acid, esters of crotonic acid, crotononitrile, vinyl imidazole; and basic amine monomers can be polymerised as the free amine, protonated salts or as a quaternised amine salt. Where a monomer is indicated with a prefix in brackets (e.g. meth) it shall be understood that it be used in a form with or without the methyl substitution, or alternatively an alternative alkyl group may be present. For example, in the case of acrylic acid, methacrylic acid or another derivative such as ethacrylic acid may be used.

In one highly preferred embodiment of the invention, the water soluble polymer is a modified PVOH. Preferably, the modified PVOH is present in an amount of from about 0.1 to about 99% based on the weight of the total coating, more preferably from about 1 to about 75%, even more preferably from about 1 to about 50% based on the weight of the total coating.

In another particular embodiment, the modified PVOH is present in an amount of from about 45% to about 99% based on the weight of the total coating. Suitably, the modified PVOH is present in an amount of from about 45% to about 95% based on the weight of the total coating. More suitably, the modified PVOH is present in an amount of from about 45% to about 90% based on the weight of the total coating. Even more suitably, the modified PVOH is present in an amount of from about 45% to about 85% based on the weight of the total coating. Yet more suitably, the modified PVOH is present in an amount of from about 45% to about 70% based on the weight of the total coating

Preferred modified PVOH materials may be produced via the reaction of a suitable aldehyde directly with the ‘vinyl alcohol’ functionality of the parent PVOH based polymer or copolymer. Suitable aldehydes include: straight and branched chain alkyl aldehydes containing a branched or linear C4 to C22 carbon chain, acetals, ketals, esters, epoxides, isocyanates, suitably reactive oligomers, polymers and aromatic compounds.

The degree of modification of the PVOH based polymer may be from about 0.1% to about 50%, by this it is meant that the ‘OH’ portion of the PVOH has been replaced by the given percentage. The person skilled in the art will appreciate that, for example, in the case of the reaction of an aldehyde with ‘PVOH’ for each molar quantity of aldehyde two molar quantities of ‘OH’ are substituted via the acetalation reaction. Hence a 50% modified PVOH will have been reacted with 25% of a suitable aldehyde, and, of course the degree of hydrolysis of the PVOH will dictate the maximum level of substitution possible.

In another embodiment, the modified water-soluble polymer is a PVOH based polymer in which at least a portion of the H atoms of the —OH groups have been exchanged for 2-10C aldehyde groups (i.e. by an ester linkage). Suitably, between 0.1 and 50% of the —OH groups have been exchanged for 2-10C aldehyde groups. More suitably, between 1 and 15% of the —OH groups have been exchanged for 2-10C aldehyde groups. Even more suitably, between 2 and 12% of the —OH groups have been exchanged for 2-10C aldehyde groups.

In another embodiment, the modified water-soluble polymer has a structure that can be schematically represented by formula (III) shown below:

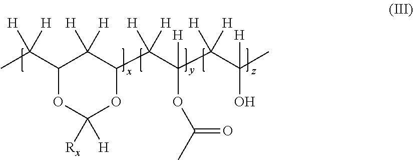

wherein each Rₓ is (1-9C)alkyl, (2-9C)alkenyl or (2-9C)alkynyl,
x denotes the proportion of modified PVOH monomeric moieties,
y denotes the proportion of residual acetate monomeric moieties present in the polymer following hydrolysis to yield the PVOH, and
z denotes the proportion of unmodified PVOH monomeric moieties.

It will also be understood that formula (III) shows a schematic representation illustrating the structures of the various monomeric moieties that collectively constitute the modified PVOH. Hence, formula (III) does not necessarily imply that the water-soluble polymers are block copolymers or alternating copolymers. On the contrary, monomeric moieties w, x, y and z may be randomly distributed throughout polymers falling within the scope of formula (III). It will also be understood that PVOH-based polymers falling within the scope of formula (III) may comprise, in addition to monomeric moieties x, y and z, other monomeric moieties.

In another embodiment, the water-soluble polymer is the product formed by reacting a PVOH-based polymer with a 2-10C aldehyde, such that between 0.1 and 50% of the —OH groups are exchanged for 2-10C aldehyde groups. Suitably, the water-soluble polymer is the product formed by reacting a PVOH-based polymer with a 2-10C aldehyde, such that between 1 and 15% of the —OH groups are exchanged for 2-10C aldehyde groups. More suitably, the water-soluble polymer is the product formed by reacting a PVOH-based polymer with a 2-10C aldehyde, such that between 2 and 12% of the —OH groups are exchanged for 2-10C aldehyde groups. Even more suitably, the water-soluble polymer is the product formed by reacting a PVOH-based polymer with a 2-10C aldehyde, such that between 2 and 10% of the —OH groups are exchanged for 2-10C aldehyde groups. Most suitably, the water-soluble polymer is the product formed by reacting a PVOH-based polymer with a 2-10C aldehyde, such that between 4 and 9% of the —OH groups are exchanged for 2-10C aldehyde groups.

In a particularly suitable embodiment, the 2-10C aldehyde referred to hereinbefore is not substituted with a charge-conferring group. Hence, the 2-10C aldehyde may be entirely unsubstituted, or may be substituted with one or more groups that are not cation-forming groups (such as amines) or anion-forming groups. In such embodiments, the resulting water-soluble polymer does not carry a permanent charge. Suitably, the 2-10C aldehyde is butyraldehyde.

In one highly preferred embodiment, the modified PVOH is a ‘butyrated’ modification—such as via the formation of an acetal with an aldehyde such as butyraldehyde, so-called “butyration”, wherein the degree of substitution (DS) by the modifying group is from about 0.1 to about 50%, more preferably, the from about 1 to about 20%, even more preferably, from about 2 to about 10%.

In one highly preferred embodiment, the modified PVOH is 5% butyrated Mowiol 4-98 or 5% butyrated Mowiol 10-98.

In one highly preferred embodiment, the modified PVOH is 8% butyrated Mowiol 4-98 or 8% butyrated Mowiol 10-98.

Other suitable water soluble polymers which may be used in addition to modified PVOH include polyvinyl pyrrolidone, celluloses and modified celluloses, gelatines, polyvinyl acetates, maleic acid containing polymers or copolymers, starches, polycarboxylic acids and salts and mixtures thereof.

The modified PVOH coating layer provides a degree of exothermic control. The degree of exotherm control is provided by the presence of a water soluble polymer as described above in combination with a salt and/or surfactant as described above.

As mentioned above, one disadvantage of peroxy bleaching benefit agents is their relatively poor stability when stored in the presence of typical detergent components, or in the presence of oxidisable materials such as organic materials which may include waxes and/or organic polymers. Such reactive oxidising agents may become unstable at elevated temperatures and in the presence of material which is readily oxidisable, considerable heat may be generated by reaction between the two. As a result a so-called self-accelerated-decomposition may occur accompanied by a significant exotherm.

Surprisingly it has been found that the presence of a layer of modified poly(vinyl alcohol) and a salt (or surfactant), either as a primer layer, i.e. in contact with the peroxy bleach surface, or as a layer at any point in the coating process, such as a ‘top-coat’ or an intermediate layer, affords an effective means by which the exothermicity of the composite particle may be controlled; such additives (commonly known as phlegmatizers) are components used to stabilise or desensitise reactive materials, particularly against undesired overheating. It is well known in the literature that poly(vinyl alcohol) (‘PVOH’), which exists more correctly as a co-polymer of ‘vinyl alcohol’ and vinyl acetate, may be used as a ‘combustion control agent’. It is shown, for example, in Sekisui Specialty Chemicals Publication 2011-PVOH-9030 (which may be found on-line at www.selvol.com) that PVOH is able to gradually decompose when heat is applied to firstly release water and acetic acid (acetic acid is released as a result of the presence of vinyl acetate in ‘PVOH’ which may be present in a greater or lesser extent depending on the degree of hydrolysis of the ‘PVOH’) and then to further decompose in the presence of oxygen to produce carbon dioxide. This gradual decomposition process serves to absorb and to reduce the effect of heating applied upon a substrate.

Another embodiment of the invention therefore relates to the use of a blend comprising:

(i) at least one water soluble polymer; and
(ii) at least one salt, or at least one surfactant, or a mixture thereof;
as a phlegmatizer.

Another embodiment of the invention relates to the use of a blend comprising:

(i) at least one water soluble polymer; and
(ii) at least one salt, or at least one surfactant, or a mixture thereof;
to stabilise or desensitise a benefit against undesired overheating.

In one preferred embodiment, the blend is admixed with a composite comprising the at least one benefit agent.

In another preferred embodiment, the blend is coated onto one or more core units comprising the at least one benefit agent.

The benefit may be a reactive species, such as a peroxy bleach material.

It is generally undesirable to have organic material in the presence of an oxidising material such as a peroxy bleach material. Therefore it is surprising that the incorporation of a modified PVOH and a salt (or surfactant) layer, which is in itself an organic material, within the composite either as a discrete layer or as a component part of the composite, acts as an effective phlegmatizer which controls undesired overheating.

Modified PVOH is described in WO 2004/031271 and WO2009/103576. WO 2004/031271 describes the synthesis and process by which suitable modifications to PVOH may be made in order to produce a modified PVOH film which is resistant to dissolution in concentrated surfactant solution but which dissolves quickly when the surfactant solution is diluted sufficiently. WO2009/103576 also describes how multiple modifications may be made to modify PVOH and further describes how particles may be produced which are coated in this modified PVOH. Whilst mention is made of the utility afforded by coating particles with these modified PVOH materials, these patents do not in any way teach that modified PVOH and a salt (or surfactant) has the surprising ability to reduce or remove the excess heating or runaway reaction produced as a result of an oxidising agent, such as sodium percarbonate, being in the presence of an oxidisable material, such as an organic material, during a thermal event.

Blend

The blend may be synonymously referred to herein as the coating layer (B).

The blend comprises a water-soluble polymer and at least one ionic species. The blend may optionally comprise a wax or wax-like substance and an amphiphilic polymer. Suitably the blend comprises a water-soluble polymer being a poly(vinyl alcohol) polymer modified by reaction with a 2-10C aldehyde, such that 1-15% of the available —OH groups have been modified; and at least one ionic species.

In an embodiment, the composite comprises between 0.1 and 99.9% of the blend based on the total weight of the composite. It will be understood that, depending on the particular application in which the composite is intended to be used, the benefit agent core may be coated to any extent. For example, where it is desirable to increase the barrier between the benefit agent core and the surrounding environment, it may be desirable to a high quantity of blend coating. Conversely, in applications where the surrounding environment is such that a reduced barrier would be sufficient to adequately encapsulate the benefit agent core, it may be advantageous to use much lower quantities of blend coating.

The composite may comprises between 0.1 and 99.9% of the blend based on the total weight of the composite. Alternatively, the composite may comprises between 0.1 and 80% of the blend based on the total weight of the composite. Alternatively, the composite may comprises between 0.1 and 60% of the blend based on the total weight of the composite. Alternatively, the composite may comprises between 0.1 and 50% of the blend based on the total weight of the composite

In a particularly suitable embodiment, the composite comprises between 0.1 and 30% of the blend based on the total weight of the composite. Suitably, the composite comprises between 2 and 15% of the blend based on the total weight of the composite. More suitably, the composite comprises between 4 and 8% of the blend based on the total weight of the composite. Such compositions are particularly suitable in laundry detergent formulations (e.g. liquids and powders).

Optional Layer (C)

In one highly preferred embodiment of the invention, the composite comprises a further coating layer (C) comprising a blend comprising:
(i) at least one wax or wax-like substance; and
(ii) at least one amphiphilic polymer.

In one highly preferred embodiment, the further coating layer (C) is positioned between the core unit and the coating layer (B).

However, in an alternative preferred embodiment, the coating layer (B) is positioned between the core unit and the further coating layer (C).

Other embodiments of the invention may comprise one or more additional layers to (B) and (C), e.g. a primer layer, a filler layer, a layer of an inorganic material, an adhesion promoting layer or a de-tacifying layer. These layers may be present at any position within the composite.

Other embodiments of the invention may be such that the particle itself is formed from a matrix comprising the core components (e.g. a bleach) and at least one modified poly(vinyl alcohol) and a salt (or surfactant) and optionally a wax or wax-like substance and at least one amphiphilic polymer. Such a matrix particle may additionally be coated further with layers as described herein.

The optional coating (C) may comprise the wax or wax-like substance and the amphiphilic polymer in a ratio of 75-95:5-25. Suitably, the optional coating (C) comprises the wax or wax-like substance and the amphiphilic polymer in a ratio of 80-90:10-20. In a particular embodiment, the optional coating (C) comprises the wax or wax-like substance and the amphiphilic polymer in a ratio of 85:15.

Wax or Wax-Like Substance

As mentioned above, an optional coating layer (C) on said one or more core units may comprise a blend comprising at least one wax or wax-like substance and at least one amphiphilic polymer.

The term “wax or wax-like substance” refers to a material which is composed primarily of hydrocarbon groups such as a polymer formed from the polymerisation of alpha-olefins, but may also refer to a natural wax which may contain various types of chemical functionality depending on the source and the natural processes involved in its production. It should be noted that whilst natural waxes contain varied chemical functionality, in general, the degree of functionalization is not sufficient to make the wax responsive in the manner which is described herein in respect of the amphiphilic polymer.

In essence the wax or wax-like substance is a material which is waterproof. This material may preferably be described as a wax, that is to say a material that has some plasticity at normal ambient temperatures and a melting point of above around 30° C. A single wax may be used or a blend of two or more different waxes may be used in the composite.

Waxes are organic compounds that characteristically consist of long alkyl chains. The wax may be a natural wax or a synthetic wax. Natural waxes are typically esters of fatty acids and long chain alcohols. Terpenes and terpene derivatives may also be described as natural waxes. Synthetic waxes are typically long-chain hydrocarbons lacking functional groups.

In one preferred embodiment, the wax is a petroleum wax. Petroleum waxes include, but are not limited to, the following: paraffin waxes (made of long chain alkane hydrocarbons), microcrystalline waxes (e.g. with very fine crystalline structure), and petroleum jelly. For example, the Bareco Baker Hughes family of microcrystalline waxes are petroleum-derived microcrystalline waxes consisting of complex mixtures of paraffinic, isoparaffinic, and naphthenic hydrocarbons.

Paraffin waxes represent a significant fraction of petroleum and are refined by vacuum distillation. Paraffin waxes are typically mixtures of saturated n- and iso-alkanes, naphthenes, and alkyl- and naphthene-substituted aromatic compounds. The degree of branching has an important influence on the properties.

Other synthetic waxes include, but are not limited to, polyethylene waxes (based on polyethylene), Fischer-Tropsch waxes, chemically modified waxes (for example, esterified or saponified), substituted amide waxes, and polymerised α-olefins. Some waxes are obtained by cracking polyethylene at 400° C. The products have the formula (CH₂)ₙH₂, where n ranges between about 50 and 100. Additionally synthetic waxes may contain chemical functionalization such as the carboxylated wax VYBAR C6112 produced by Baker Hughes from which it is possible to produce other further functionalization such as pegylation, by reaction with a suitable mono-, di-, or polyhydric alcohol or alkoxylated also possible, for example, silylation, siliconylisation and the like.

Examples of suitable naturally occurring materials include beeswax, candelilla wax, carnauba wax, paraffin wax, ozokerite wax, ceresine wax, montan wax. Synthetic waxes are also available and examples in this class include microcrystalline waxes such as the Bareco™ range of microcrystalline waxes; the VYBAR™ range of highly branched polymers derived from the polymerisation of alpha olefins; the PETROLITE™ range of polymers and the POLYWAX™ range of polyethylenes.

In one highly preferred embodiment, the wax or wax-like material is selected from the VYBAR™ (Baker Hughes) range of highly branched polymers derived from the polymerisation of alpha olefins and may be a single product chosen from the range or a mixture of two or more products in the range. Particularly preferred is the highly branched synthetic wax VYBAR 260™.

Blends of two or more natural waxes, or two or more synthetic waxes, or blends of one or more natural waxes and one or more synthetic waxes or blends of chemically functionalised synthetic waxes with other synthetic or natural waxes are also suitable for use in the present invention. As will be appreciated by those skilled in the art, such blends can be used to blend the properties of the two together, for instance allowing the melting point of the mixture to be finely tuned. It is also possible that wax or wax-like material may be formed by the mixture of two or more different materials that may not themselves be individually wax like. It can be envisioned that a number of mixtures may be suitable for this purpose such as oils which have been thickened by the addition of metal soaps, clays and polymer additives designed to harden oils and fats such as silica gels, polypropylenes and polyethylenes. As will be appreciated by those skilled in the art, most naturally derived waxes are themselves typically complex mixtures of different chiefly hydrophobic chemical species. It should be appreciated that the foregoing list is not exhaustive but merely illustrative of the range of natural and synthetic waxes available to the formulator. For the purposes of this invention, a particular material may be chosen with the intention of providing a suitable barrier layer for the core particle and having the necessary chemical and physical characteristics such as solubility, melting temperature, barrier properties (i.e. a barrier to reactive species, water and other formulation ingredients), crystalline and/or amorphous properties and hardness which allow for application to the core particle and which provide for an effective barrier.

Amphiphilic Polymer

As mentioned, the optional further coating layer (C) on said one or more core units comprises a blend of at least one wax or wax-like substance and at least one amphiphilic polymer.

The purpose of the amphiphilic polymer in admixture with the wax or wax-like material is to provide a locus of weakness when the mixture finds itself in a trigger environment i.e. when the external environment is such that the chemical functionality present in the amphiphilic polymer will respond to the environment and dissolve or disperse, thereby causing the destabilisation of the mixture itself which, when present as a coating, leads to the release of the core material.

The amphiphilic polymer therefore needs to be a material which may be mixed with the wax or wax-like material to produce either a single phase coating or a multiple phase coating or a solid dispersed within the wax or wax-like material and must contain chemical functionality which will respond to an external environment to produce a response in its chemistry.

In one preferred embodiment, the amphiphilic polymer is an amphiphilic copolymer.

As used herein, the term “copolymer” refers to a polymeric system in which two or more different monomers are polymerised together.

As used herein, the term “amphiphilic copolymer” refers to a copolymer in which there are clearly definable hydrophilic and hydrophobic portions.

In one preferred embodiment of the invention the polymer graft is a hydrophilic water soluble polymer that is able to act as the locus of weakness in the coating. For instance it may preferably be a poly(ethylene glycol)/poly(propylene oxide), poly(vinyl alcohol), poly(vinyl pyrrolidone), poly(styrene sulfonate), poly(acrylamidomethylpropylsulfonic acid) or similar molecules. Grafts like poly(ethylene/propylene glycol) are also preferred as they increase the ability of the system to react to changes in ionic strength.

The composite of the present invention may contain one or more amphiphilic copolymers. In one embodiment, the composite of the present invention comprises between about one and about four amphiphilic copolymers, for example one, two, three, or four copolymers, preferably one or two copolymers, most preferably one copolymer.

In one preferred embodiment of the present invention, the amphiphilic copolymer has a hydrophilic-lyphophilic (or hydrophobic) balance (HLB) as measured by Griffin's method of less than or equal to about 15, preferably less than or equal to about 10, more preferably between about 1 and about 10, yet more preferably between about 2 and about 9, for example, between about 3 and about 8. The Griffin method values are calculated by: hydrophilic-lyphophilic balance=20×molecular mass of the hydrophilic portion/molecular mass of the whole molecule.

The molecular mass of the hydrophilic and hydrophobic portions of the polymer can be estimated from the quantities of the relevant monomers put in as feedstocks in the manufacture of the amphiphilic copolymer and based on an understanding of the kinetics of the reaction. The composition of the final product can be checked by comparing the relevant intensities of signals from each block or portion using ¹H nuclear magnetic resonance spectroscopy. Alternatively, other quantitative spectroscopic techniques such as infra-red spectroscopy or ultra-violet visible spectroscopy can be used to confirm the structure, provided the different portions give clearly identifiable and measurable contributions to the resulting spectra. Gel permeation chromatography (GPC) can be used to measure the molecular weight of the resulting materials.

As described herein there are available in the marketplace a range of amphiphilic copolymers which have been synthetically modified so as to produce a material which is responsive to a change in chemical environment or media. As used herein, “amphiphilic polymers” are those that have one or more well defined hydrophilic domains and one or more hydrophobic domains. Preferably, the amphiphilic polymer is a copolymer.

A wide range of amphiphilic copolymers may be suitable for use in the invention provided that they contain hydrophobic domains that are sufficient to ensure sufficient compatibility with the wax or wax-like material such that the encapsulates are stable in a formulated product. Any amphiphilic copolymer used in the invention must have sufficient hydrophilic functionality such that the amphiphilic polymer is responsive to changes in the formulation environment. As is well known in the art, in general the structures fall into several different forms of architectures including block copolymers, graft copolymers, highly branched and chain-extended or cross-linked polymers. A person skilled in the art of polymer chemistry would be familiar with such forms, together with methods for their preparation.

Many different polymers are suitable for use in the invention, provided they fulfil the key requirements of an amphiphilic polymer, that is to say they comprise a hydrophobic block that has compatibility with the wax or wax-like material, and a hydrophilic block capable of engineering responsiveness to changes in the environment.

By way of example, polymers comprising poly(ethylene glycol) units, or portions (e.g. blocks or grafts) are particularly suitable for use as amphiphilic polymers in the context of the invention due to their responsive nature to ionic strength and to water activity.

Preferably the hydrophilic portions may be based on a poly(alkylene oxide), such as polyethylene oxide or a copolymer thereof. Similarly preferred groups include polyglycidol, poly(vinyl alcohol), poly(ethylene imine), poly(styrene sulfonate) or poly(acrylic acid). Likewise polymers comprising poly(vinyl alcohol) units or portions are also responsive to changes in ionic strength and to water activity.

Particularly useful hydrophobic units or portions are those polymers based on hydrophobic monomers such as olefins (e.g. ethylene, propylene), dienes (e.g. butadiene or isoprene) and ethylenically unsaturated monomers such as isobutylene or octadecene. Aromatic monomers like styrene and alpha-methyl styrene may also be used. In a preferred embodiment, the hydrophobic portion may contain an acid, diacid or anhydride based monomer such as maleic anhydride. Acid and anhydride groups are preferred as they serve as a point of attachment and can potentially increase the responsiveness of the system.

A number of examples of suitable amphiphilic copolymers that have utility in the invention are given below.

Amphiphilic block copolymers may be manufactured by a variety of methods including the sequential addition polymerisation of two or more monomers in a linear manner typically using a living or controlled polymerisation technique. Alternatively they may be produced by the propagation and polymerisation of a polymeric chain from an existing polymer, or by chemically reacting well defined blocks together using coupling or click chemistry. A wide variety of such materials are available commercially and have utility in the invention. Many commercial amphiphilic block copolymers materials are produced via the ethoxylation of a preformed alcohol functionalised hydrocarbon block. This hydrophobic block or domain may be, for instance, manufactured by the polymerisation of a hydrophobic monomer, chemical synthesis or processing of petrochemical or natural feedstocks e.g. by the isolation of natural fatty alcohols. The polymerisation of ethylene oxide is then initiated on the alcohol and propagates to form a polyethylene block.

In one highly preferred embodiment the amphiphilic polymer is a block copolymer of ethylene and ethylene oxide. In one highly preferred embodiment the amphiphilic polymer is selected from the range of block copolymers of ethylene and ethylene oxide known as Unithox™ (Baker Hughes) and may be a single product in this range or a mixture of two or more.

Unithox™ polymers are understood to be manufactured by the polymerisation of ethylene oxide (i.e. ethoxylation) from an alcohol functionalised polyethylene wax (which may also be described as a long chain saturated hydrocarbon alcohol). The ratio of PE to PEO in these materials has a profound effect upon their aqueous solution properties and in particular their HLB value (Hydrophilic/Lipophilic Balance) which is a calculation by which a particular amphiphilic material may be classified in terms of its hydrophilicity or hydrophobicity. Importantly, it is possible to identify certain ratios of PE:PEO within the Unithox™ range which, when coated as a layer onto a core particle will show good water-proofing properties when such particles are suspended into a low water containing media. ‘Low water containing’ refers to a liquid media which has approximately less than 20% water—as is often found in unit liquid dose and gel laundry products which may be packaged in dissolvable polymeric sachets. As mentioned above, such particles coated with Unithox™ are water-proof when exposed to a liquid media of low water content. However, the applicant has found that on dilution into water, such as in application usage when, for example, used in a laundry wash, the Unithox™ coating will dissolve/disperse and hence release the active core contents. The applicant has surprisingly found that Unithox™ behaves in a responsive manner to dilution/ionic strength. The applicant has also found that the blending of other hydrophobic materials, such as those described herein as the wax or wax-like material, into Unithox™ provides for a coating which has excellent stability, i.e. the active core when coated with a suitable blend of wax or wax-like material and Unithox™ is stable for extended periods in, for example, common commercial laundry products over significant periods of time and particularly products which have low water content (i.e. below around 20% water). Such particles coated, for example, with a suitable blend of water-proof material (e.g. wax or wax-like material) in combination with Unithox™ provides for excellent stability of the active core particles (the ‘payload’) but, due to the responsive nature of the Unithox™ will release the active upon application usage and will do so in a short enough timeframe to be suitable for use in typical household and industrial applications.

As mentioned above Unithox™ are block copolymers of commercially produced ethylene oxide with a hydrophobic (e.g. polyethylene) based block. It will be appreciated that it will be possible to form a similar structure by reacting a functionalised polyethylene material with an appropriately functionalised PEO (PEG) graft. For instance Baker Petrolite supply the Unicid™ range of materials which incorporate carboxylic acid functionality into a polyethylene based polymer wax and the CERAMER™ range—a polyethylene based polymeric material incorporating maleic anhydride functionality. These can potentially be reacted with mono alcohol or difunctional alcohol functionalised PEG resulting in the synthesis of AB or ABA amphiphilic block copolymers respectively.

Amphiphilic graft copolymers can be manufactured by several different methods, for instance a preformed backbone can be reacted with preformed grafts (sometimes called the “grafting to” method). Alternatively, polymerisation can be initiated from a suitably functionalised backbone such that the grafts are generated in situ (“grafting from” approach). Finally, a polymer or oligomer with a polymerisable group (a macromonomer) can be polymerised to yield a graft copolymer in which the original polymer chains are pendant to the backbone (the “grafting through” or macromonomer approach). Amphiphilic graft copolymers suitable for use in the invention typically contain suitable chemical functionality incorporated in the polymer backbone, or pendant to this, or grafted, or present in a random arrangement, or as blocks, or may be subjected to post-production functionalization. In essence the material must include a hydrophile (X) and also a hydrophobe (Y) in the correct proportions so as to effect the required dissolution properties. Such constructs of X and Y are shown in Scheme 1 below. The skilled person would be aware of various other common architectures available.

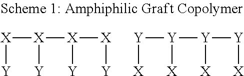

In one embodiment of the invention, the amphiphilic copolymer is a graft copolymer comprising a hydrophobic straight or branched chain carbon-carbon backbone having at least one hydrophilic side chain attached thereto.

In a preferred embodiment of the invention, the hydrophilic side chains of the graft copolymer are each independently of formula (I),

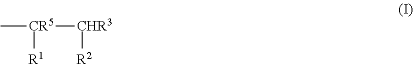

wherein R¹ and R² are each independently H, —C(O)WR⁴ or —C(O)Q;

provided that at least one of R¹ and R² is the group —C(O)Q;

or R¹ and R² together form a cyclic structure together with the carbon atoms to which they are attached, of formula (II)

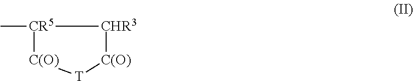

wherein:

R³ and R⁵ are each independently H or alkyl;

W is O or NR⁴;

Q is a group of formula —X¹—Y—X²P;

T is a group of formula —N—Y—X²—P;

X¹ is O, S or NR⁴;

X² is O, S, (CH₂)ₚ or NR⁴;

p is 0 to 6;

each R⁴ is independently H or alkyl;

P is H or another backbone; and

Y is a hydrophilic polymeric group.

As used herein, the term “alkyl” encompasses a linear or branched alkyl group of about 1 to about 20 carbon atoms, preferably about 1 to about 10 carbon atoms, more preferably about 1 to about 5 carbon atoms. For example, a methyl group, an ethyl group, an isopropyl group, a n-propyl group, a butyl group, a tert-butyl group or a pentyl group.

In a preferred embodiment of the invention, the hydrophilic polymeric group Y is a poly(alkylene oxide), polyglycidol, poly(vinyl alcohol), poly(ethylene imine), poly(styrene sulfonate), poly(acrylamidomethylpropylsulfonic acid) or poly(acrylic acid). More preferably, the hydrophilic polymeric group Y is a poly(alkylene oxide), such as polyethylene oxide or a copolymer thereof.

In a further preferred embodiment of the invention, the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum b+c has a value in the range of from about 10 to about 250, more preferably, from about 10 to about 120.

In a further preferred embodiment of the invention, the graft copolymer has from 1 to 5,000, preferably from about 1 to about 300, and more preferably from about 1 to about 150, pendant hydrophilic groups attached thereto. For example, the graft copolymer may have between about 1 to about 10, between about 1 to about 5, or between about 2 to about 8 pendant hydrophilic groups attached thereto.

In an alternative embodiment of the invention, the amphiphilic copolymer is a graft copolymer comprising a hydrophilic straight or branched chain carbon-carbon backbone having at least one hydrophobic side chain attached thereto.

Where the amphiphilic copolymer is a graft copolymer, each side chain of the graft polymer preferably has a molecular weight from about 800 Da to about 10,000 Da. For example, each side chain preferably has a molecular weight between about 1000 to about 7,500 Da, between about 2,500 Da to about 5,000 Da or between about 6,000 Da and about 9,000 Da.

In another preferred embodiment of the invention, the amphiphilic copolymer is a block copolymer comprising hydrophilic blocks and hydrophobic blocks in a straight or branched chain carbon-carbon backbone.

In one preferred embodiment of the invention, the straight or branched chain carbon-carbon backbone has at least one side chain attached thereto. The side chain(s) may be hydrophobic or hydrophilic. Examples of suitable side chains include those described above with reference to amphiphilic graft copolymers. Preferably the block copolymer has a straight chain carbon-carbon backbone comprising hydrophilic blocks and hydrophobic blocks. In a further preferred embodiment, the amount of hydrophilic polymer by weight in the final composition is between from about 5 to about 60%.

A graft copolymer is typically produced by the reaction of hydrophilic grafts with a single reactive site on the carbon-carbon backbone, i.e. the reaction uses monofunctional grafts. In order to create a cross-linked or chain-extended copolymer it is necessary to incorporate a hydrophilic graft that has two sites that will react with the carbon-carbon backbone, i.e. a difunctional hydrophilic graft that can act as a cross-linking agent is used.

Preferably, the cross-linked or chain-extended copolymers comprise a linear or branched carbon-carbon backbone and a difunctional graft or a mixture of monofunctional and difunctional grafts. More preferably, the cross-linked or chain-extended copolymers comprise a carbon-carbon backbone functionalized with maleic anhydride or a derivative thereof (as described herein) and an alkylene oxide such as those described in formula (II). Most preferably, the cross-linked or chain-extended copolymers comprise a carbon-carbon backbone derived from polyisoprene or polybutadiene functionalized with maleic anhydride or a derivative thereof, and further comprise hydrophilic grafts, preferably being polyethylene oxide or a copolymer thereof.

In one preferred embodiment of the invention, the carbon-carbon polymer backbone is derived from a homopolymer of an ethylenically-unsaturated polymerisable hydrocarbon monomer or from a copolymer of two or more ethylenically-unsaturated polymerisable hydrocarbon monomers.

More preferably, the carbon-carbon polymer backbone is derived from an ethylenically-unsaturated polymerisable hydrocarbon monomer containing 4 or 5 carbon atoms. In one highly preferred embodiment of the invention, the carbon-carbon polymer backbone is derived from isobutylene, 1,3-butadiene, isoprene or octadecene, or a mixture thereof.

In one preferred embodiment of the invention, the copolymer comprises a carbon-carbon backbone (e.g. polyisoprene or polybutadiene) onto which maleic anhydride or maleic anhydride acid/ester groups have been grafted. Preferably, the carbon-carbon backbone comprises from about 1 to about 50 wt % maleic anhydride group. As used herein, the term maleic anhydride (MA) group encompasses maleic anhydride, maleic acid and salts thereof and maleic acid ester and salts thereof and mixtures thereof. The maleic anhydride group coupling chemistry provides a convenient method for attaching the grafts to the copolymer backbone. However, the skilled person would appreciate that other functional groups would be equally effective in this regard.

By way of example, the reaction of another acyl group (e.g. a suitable carboxylic acid or acyl chloride) with a hydroxyl functionalised polymer will be suitable for forming an ester linkage between the graft and backbone. Various strategies for performing coupling reactions, or click chemistry, are also known in the art and may be utilised by functionalising the backbone with suitable groups, possibly in the presence of a suitable catalyst. For instance the reaction of an alkyl or benzyl chloride group on the backbone with a hydroxyl group for instance (i.e. a Williamson coupling), or the reaction of a silicon hydride with an allyl group (a hydrosilyation reaction) could be utilised.

As used herein, the term “aryl” encompasses any functional group or substituent derived from an aromatic ring or a heteroaromatic ring, preferably a C6 to C20 aromatic ring, for example, phenyl, benzyl, tolyl or napthyl.

Preferably, the carbon-carbon backbone comprises from about 1 to about 50 wt % maleic anhydride.

In one preferred embodiment, the backbone of the amphiphilic polymer has a molecular weight from about 1,000 Da to about 10,000 Da.

In another preferred embodiment of the invention, the carbon-carbon backbone is a copolymer of:
(i) maleic anhydride, maleic acid or salts thereof or maleic acid ester or salts thereof or a mixture thereof; and
(ii) one or more ethylenically-unsaturated polymerisable monomers.

The MA group monomer is thus present in the actual backbone rather than pendant to it.

A number of such materials are available commercially, most typically obtained by the radical polymerisation of a mixture of a maleic anhydride group and one or more other ethylenically unsaturated monomers. It will be envisioned that any number of monomers, though most typically a mixture of a maleic anhydride group and one other monomer (to make a bipolymer) or two other polymers (to make a terpolymer) will be used.

Preferably, the maleic anhydride group monomer is maleic anhydride.

Preferably, the other monomer is ethylene, isobutylene, 1,3-butadiene, isoprene, a C₁₀-C₂₀ terminal alkene, such as octadecene, styrene, or a mixture thereof. Most preferably, the other monomer is isobutylene or octadecene.

The percentage of the monomers, and thus functionality in the resulting polymer, may be altered to provide optimal fit to the application. One advantage of backbones prepared by such a method is that they offer the potential for higher loadings of maleic anhydride (MA) potentially available for reaction with hydroxy, amine, or sufide functionalised grafts (e.g. suitable poly(ethylene glycols) (PEGs), monomethoxy poly(ethylene glycols) MPEGs or amine functionalised alkyl ethxoylates like the Jeffamine™ range from Huntsman).

In one aspect of the invention the backbone is an alternating copolymer prepared by mixing and subsequently polymerising equimolar quantities of a MA group and another monomer.

A particularly preferred backbone copolymer is poly(isobutylene-alt-maleic anhydride) (PIB-alt-MA):

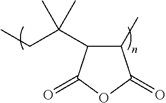

wherein n is between 5 and 4,000, more preferably 10 and 1200.

This polymer is available commercially from Sigma-Aldrich and Kuraray Co. Ltd; Kuraray supply the material under the trade name ISOBAM.

A further preferred backbone copolymer is poly(maleic anhydride-alt-1-octadecene) (C18-alt-MA) (available from the Chevron Philips Chemical Company LLC).

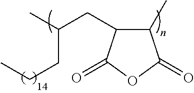

wherein n is between 5 and 500, more preferably 10 and 150.

Chevron Philips make a range of materials (both high and low viscosity) in their PA18 Polyanhydride resins range that are preferred backbones in the invention. PA18 is a solid linear polyanhydride resin derived from 1-octadecene and maleic anhydride in a 1:1 molar ratio.

It will be appreciated by those skilled in the art that a number of other backbones in which maleic anhydride is included in the backbone, either by grafting the maleic anhydride as an adduct, or by copolymerising maleic anhydride with one or more other monomers are useful in the invention.

A range of polybutadiene polymers functionalised with maleic anhydride are sold under the Ricon brand by Sartomer (e.g. Ricon 130MA8) and Lithene by Synthomer (e.g. N4-5000-5MA). A particularly preferred backbone is Lithene N4-5000-5MA. A further particularly preferred backbone is Lithene N4-5000-15MA. A number of useful backbones are also manufactured by Kraton (e.g. Kraton F G) and Lyondell (e.g Plexar 1000 series) in which maleic anhydride is grafted onto polymers or copolymers of monomers such as ethylene, propylene, butylene, styrene and/or vinyl acetate.

Poly(styrene-alt-maleic anhydride) is available from a number of suppliers including Sartomer under the SMA trade name. Poly(ethylene-alt-maleic anhydride) is available from a number of suppliers including Vertellus under the ZeMac trade name. Poly(methyl vinyl ether-alt-maleic anhydride) is available from International Speciality Products under the Gantrez trade name. Poly(ethylene-co-butyl acrylate-co-maleic anhydride) materials can be obtained from Arkema, and are sold under the trade name of Lotader (e.g. 2210, 3210, 4210, and 3410 grades). Copolymers in which the butyl acrylate is replaced by other alkyl acrylates (including methyl acrylate [grades 3430, 4404, and 4503] and ethyl acrylate [grades 6200, 8200, 3300, TX 8030, 7500, 5500, 4700, and 4720) are also available and also sold in the Lotader range. A number of the Orevac materials (grades 9309, 9314, 9307 Y, 9318, 9304, 9305) are suitable ethylene-vinyl acetate-maleic anhydride terpolymers.

In many cases in addition to, or instead of a maleic anhydride functionalised material a derivative of a diacid, mono ester form, or salt is offered. As will be obvious to those skilled in the art many of these are also suitable in the invention.

Similarly, suitable side chains precursors are those discussed below, such as mono methoxy poly(ethylene glycol) (MPEG), poly(vinyl alcohol) and poly(acrylic acid). These may for instance be purchased from the Sigma-Aldrich company. Suitable polyethylene imines are available from BASF under the Lupasol trade name.

In one preferred embodiment, the amphiphilic copolymer is prepared by reacting a compound of formula (III),

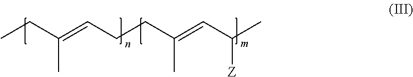

wherein Z is a group of the formula (IV),

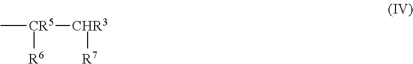

wherein R³ and R⁵ are each independently H or alkyl, and R⁶ and R⁷ are each independently H or an acyl group, provided that at least one of R⁶ and R⁷ is an acyl group, or R⁶ and R⁷ are linked to form, together with the carbon atoms to which they are attached, a group of formula (V),

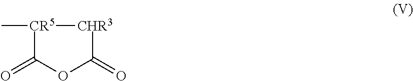

where n and m are each independently an integer from 1 to 20,000. Preferably m is 1 to 1,000, more preferably 1 to 100 and yet more preferably 10 to 50. Preferably n is 1 to 5,000, more preferably 5 to 2,000 and yet more preferably 10 to 1000. Preferably, m is 1 to 100 and n is 5 to 2,000.

with a side chain precursor of formula (VI)

HX¹—Y—X²P (VI)

wherein:

X¹ is O, S or NR⁴;

X² is O, S, (CH₂)ₚ or NR⁴;

p is 0 to 6;

each R⁴ is independently H or alkyl;

P is H or another backbone; and

Y is a hydrophilic polymeric group.

In one preferred embodiment, the amphiphilic copolymer is prepared by reacting a compound of formula (IIIa),

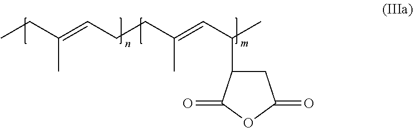

where n and m are as defined above, with a side chain precursor of formula (VI) as defined above.

In one preferred embodiment, the side chain precursor is of formula (VIa)

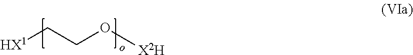

wherein X¹ is O or NH and X² is (CH₂)ₚ and o is an integer from 5 to 250, preferably 10 to 100.

In another preferred embodiment, the side chain precursor is of formula (VIb)

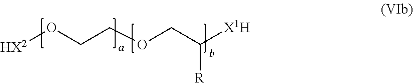

wherein R is H or alkyl, X¹ is O or NH and X² is (CH₂)ₚ and the sum of a and b is an integer from 5 to 600, preferably 10 to 100.

In one particularly preferred embodiment of the invention, the copolymer is prepared by grafting a monofunctional hydrophilic polymer such as poly(ethylene glycol) onto the maleic anhydride residues on the carbon-carbon backbone to form an amphiphilic copolymer of formula (VII),

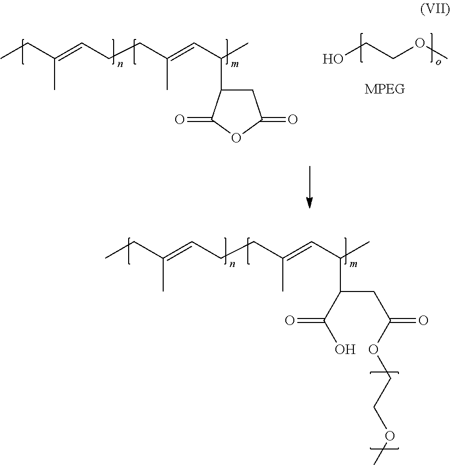

wherein each of m and n is independently an integer from 1 to 20,000. Preferably m is 1 to 1,000, more preferably 1 to 100 and yet more preferably 10 to 50. Preferably n is 1 to 5,000, more preferably 5 to 2,000 and yet more preferably 10 to 1,000. Preferably, m is 1 to 100 and n is 5 to 2,000. Preferably o is an integer from 5 to 600, preferably 10 to 100.

The above example shows an alcohol functionalized PEO reacting with the maleic anhydride on a PIP-g-MA backbone. Suitable PIP-g-MA backbones are commercially available (for example, LIR-403 grade from Kuraray, which has approximately 3.5 MA units per chain).

Further details on functionalizing polyisoprene with maleic anhydride may be found in WO 06/016179, WO 08/104546, WO 08/104547, WO 09/68569 and WO 09/68570, the contents of which are herein incorporated by reference.

In one preferred embodiment, the copolymer is prepared by adding a ratio of 2.8 equivalents of MPEG with respect to each maleic anhydride (MA) group. This essentially enables complete conversion of the maleic anhydride groups into the PEG functionalized esters.

In another preferred embodiment, the copolymer is prepared by adding a 1:1 ratio of methoxy poly(ethylene glycol) (MPEG) to maleic anhydride. After complete reaction of the MPEG, another (second) (dihydroxy) poly(ethylene glycol) (PEG) of any molecular weight (e.g. 2,000, 4,000, 6,000, 8,000 and 10,000 Da) can be added. It will be understood by those skilled in the art that MPEO, poly(ethylene oxide) methyl ether, methoxy poly(ethylene glycol) (MPEG), and poly(ethylene glycol) methyl ether are alternative methods of naming the same structure. Similarly PEO is also sometimes referred to as poly(ethylene glycol) (PEG) in the art.

In addition to functionalising unreacted maleic anhydride units, it is also possible to graft PEG or another graft onto the corresponding diacid or a mono ester derivative of MA. This will result in new PEG ester links in the place of the COOH functionality. Two suitable backbones are illustrated below.

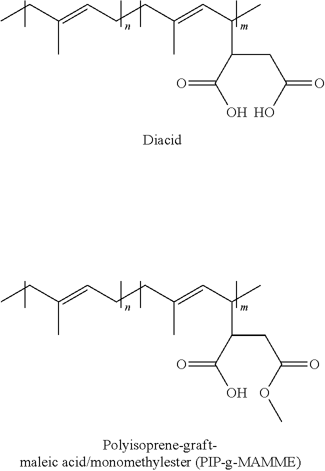 [SMILES: CC/C(C)=C/CC/C(C)=C/C(C)C(CC(=O)O)C(=O)O ; CC/C(C)=C/CC/C(C)=C/C(C)C(CC(=O)OC)C(=O)O]

Thus, in one particularly preferred embodiment, the amphiphilic copolymer is prepared by reacting a polymer precursor of formula (IIIb),

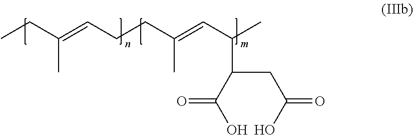

where n and m are as defined above, with a side chain precursor of formula (VI) as defined above.

In another particularly preferred embodiment, the amphiphilic copolymer is prepared by reacting a polymer precursor of formula (IIIc),

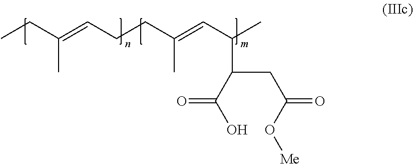

where n and m are as defined above, with a side chain precursor of formula (VI) as defined above.

In an alternative preferred embodiment, the copolymer of the invention is derived from —SH or nitrogen based (NH₂ or NHR) moieties.

In one particularly preferred embodiment, the copolymer comprises an NH₂ functionalized material. Preferably, for this embodiment, the amphiphilic copolymer is prepared from a side chain precursor of formula (VIc)

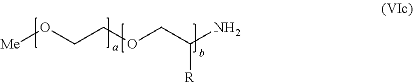

wherein R is H or alkyl, more preferably H or Me, and the sum of a and b is an integer from 5 to 250, preferably 10 to 100.

More preferably, the amphiphilic copolymer is of formulae (VIIIa) or (VIIIb) and is prepared by the following reaction:

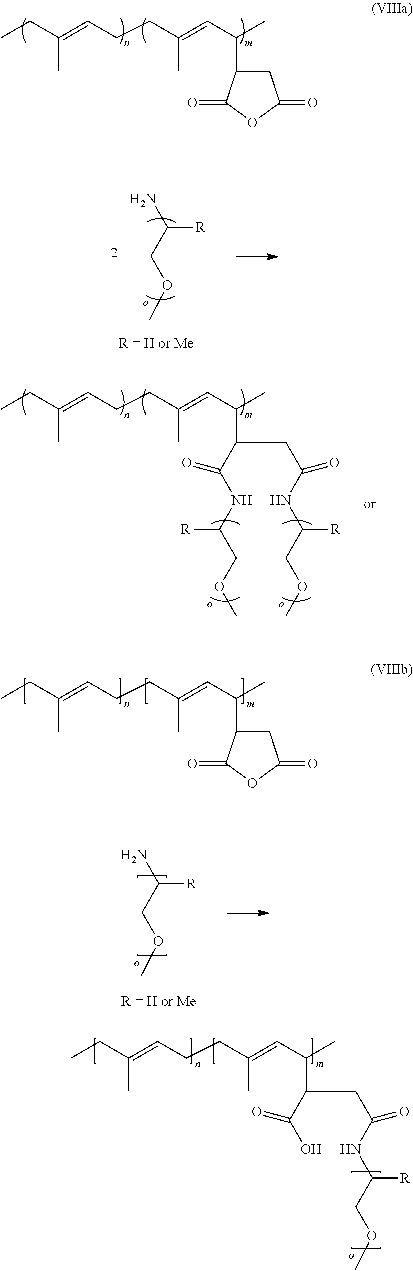

wherein each of m and n is independently an integer from 1 to 20,000. Preferably m is 1 to 1,000, more preferably 1 to 100 and yet more preferably 10 to 50. Preferably n is 1 to 5000, more preferably 5 to 2,000 and yet more preferably 10 to 1,000. Preferably, m is 1 to 100 and n is 5 to 2,000. Preferably o is an integer from 5 to 600, preferably 10 to 100.

The NH₂ functionalized material depicted above comprises two grafts on each MA, which is not possible with MPEG. This is due to the greater reactivity of the NH₂ groups compared with OH. In addition to grafting two chains per maleic anhydride unit, the greater reactivity of the NH₂ units with respect to OH leads to a product containing very small quantities of free graft.

In one particularly preferred embodiment of the invention, the amphiphilic copolymer comprises a polybutadiene backbone and pendant hydrophilic grafts attached thereto, wherein each hydrophilic graft is derived from an NH₂ functionalised ethylene oxide and propylene oxide copolymer.

In any of the above embodiments, the compounds of formula (III) may be replaced by compounds of formulae (IX) and (X):

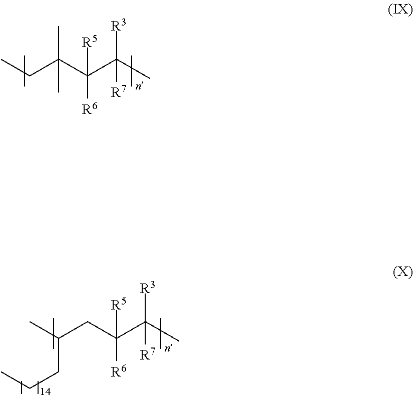

wherein n′ is 5 to 4000 and R³, R⁵, R⁶ and R⁷ are as previously defined.

Similarly, compounds of formulae (IIIa), (IIIb) and (IIIc) in any of the embodiments above may be replaced by compounds of formulae (IXa) or (Xa); (IXb) or (Xb); and (IXc) or (Xc), respectively:

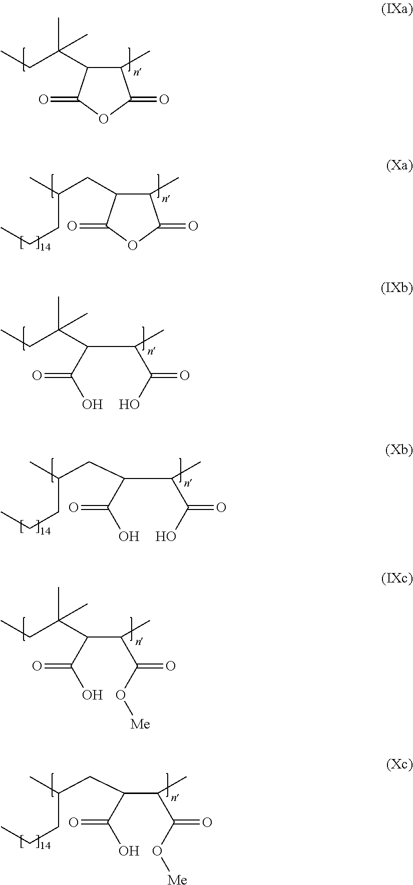

wherein n′ is as defined for compounds of formulae (IX) and (X).

In one preferred embodiment, the hydrophilic groups grafted onto the maleic anhydride groups are polymers of ethylene oxide (i.e. PEOs) copolymerised with propylene oxide. In this embodiment, the amount of propylene oxide is preferably between 1 and 95 mol percent of the copolymer, more preferably between 2 to 50 mol percent of the copolymer, and most preferably between 5 to 30 mol percent of the copolymer.

Preferably, the side chain precursor is of formula,

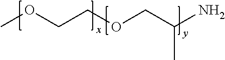

wherein x is 5 to 500, more preferably 10 to 100 and y is independently 1 to 125, more preferably 3 to 30. Preferably, x+y=6 to 600, more preferably 13 to 130. The distribution of ethylene and propylene oxide units may be in the form of blocks as depicted above or as a statistical mixture. In any case the molar ratio of ethylene oxide to propylene oxide in the copolymer will favour ethylene oxide. Such side chain precursors are sold commercially by Huntsman under the Jeffamine brand and Clariant under the Genamin name.

A particularly preferred embodiment is the graft copolymer formed from the reaction of Lithene N4-5000-5MA with the Jeffamine known as M2070. Also a particularly preferred embodiment is the graft copolymer formed from the reaction of Lithene N4-5000-15MA with the Jeffamine known as M2070.

Alternatively, it is possible to use a polymer that has two rather than one functional (e.g. OH, NH₂) units, in which both groups can react with the maleic anhydride. If these maleic anhydride groups are on different backbones, a cross-linked (or network) polymer can be formed. By controlling the ratio of graft to backbone, or by using mixtures with mono-functionalised materials, the degree of cross-linking can be controlled. Thus, it is possible to produce a material that resembles a chain extended graft copolymer (i.e. 2 or 3 graft copolymers) rather than a network by using a mixture of PEO and MPEO which chiefly comprises MPEO.

In one preferred embodiment, the amphiphilic copolymer is prepared from a mixture of PIP-g-MA (polyisoprene with grafted maleic anhydride) together with MPEG (methoxy poly(ethylene glycol) and/or PEO poly(ethylene oxide). Preferably, the MPEG and PEG have a molecular weight of about 2,000 Da.

In one preferred embodiment, the amphiphilic copolymer is prepared from a mixture of PIP-g-MaMme (polyisoprene with grafted maleic monoacid monoester) together with MPEG (methoxy poly(ethylene glycol)) and/or PEG (poly(ethylene glycol)). Preferably, the MPEG and PEG have a molecular weight of about 2,000 Da.

Example methodologies for the manufacture of the graft copolymers may be found in PCT/EP2008/066257 (WO 09/068570), PCT/EP2008/063879 (WO 09/050203) and PCT/EP2008/066256 (WO 09/068569), the teachings of which are incorporated herein by reference.

In an alternative embodiment of the invention, the amphiphilic copolymer is a cross-linked/network (or chain-extended) copolymer. Copolymers of this type may be prepared using the same or similar carbon-carbon polymer backbones to those described above in respect of amphiphilic graft copolymers. In one embodiment of the invention, the amphiphilic copolymer is a cross-linked/network copolymer comprising a hydrophobic straight or branched chain carbon-carbon backbone having at least one hydrophilic side chain attached thereto.

Fillers/Additional Components

The composite according to the invention may also comprise one or more fillers in the core and/or the coating layers. Suitable fillers include inert binder or carrier materials which can be inorganic, organic, polymeric or oligomeric. For example, inorganic salts including sulfates, carbonates, chlorides, phosphates, acetates such as sodium sulfate or sodium carbonate or clays, talcs, silicas/silicates or micas may be used. Organic polymeric materials include, for example, polysaccharides, polyamides, poly(vinyl alcohols), poly(ethers), including microcrystallines cellulose, functionalised cellulosics such as methyl, ethyl, propyl, carboxymethyl, carboxyethyl or carboxypropyl, hydroxymethyl, hydroxyethyl, or hydroxypropyl, cellulose, starch or modified starches.

In one preferred embodiment of the invention, the coating further comprises one or more additional ingredients selected from an inorganic salt, a surfactant, a plasticiser, a cosolvent, a wetting agent, a compatabiliser, a filler, a dispersant and an emulsifier. These additional ingredients aid film forming and/or aid the processability of the coating material.

Benefit Agent

The composites of the invention comprise one or more core units comprising a benefit agent. As used herein, the term “benefit agent” includes any agent that is a reactive, pro-reactive or catalytic entity that requires protection from other formulation ingredients.

Depending upon the method used to form the composites the benefit agent may be a solid, a liquid, a gel or a mixture of these. In a preferred embodiment the benefit agent is a solid at the temperature of encapsulation. In another preferred embodiment the benefit agent is a liquid which is solidified or immobilised with a matrix or filler to make it easier to handle.

In one preferred embodiment, the benefit agent is a bleach or bleach system.

In one particularly preferred embodiment the benefit agent is a bleach activator; said bleach activator comprises a material selected from tetraacetyl ethylene diamine (TAED); benzoylcaprolactam (BzCL); 4-nitrobenzoylcaprolactam; 3-chlorobenzoylicaprolactam; benzoyloxybenzene-sulfonate (BOBS); nonanoyloxybenzenesulfonate (NOBS); phenyl benzoate (PhBz); decanoyloxybenzenesulfonate (Cio-OBS); benzoylvalerolactam (BZVL); octanoyloxybenzenesulfonate (C8-OBS); perhydrolyzable esters; 4-[N-(nonaoyl) amino hexanoyloxy]-benzene sulfonate sodium salt (NACA-OBS); dodecanoyloxybenzenesulfonate (LOBS or C12-OBS); 10-undecenoyl-oxybenzenesulfonate (UDOBS or Cn-OBS with unsaturation in the 10 position); decanoyloxybenzoic acid (DOBA); (6-octanamidocaproyl)oxybenzenesulfonate; (6-nonanamidocaproyl)oxybenzenesulfonate; (6-decanamidocaproyl)oxybenzenesulfonate and mixtures thereof.

In another particularly preferred embodiment the benefit agent is a preformed peracid; said preformed peracid comprises a material selected from the group consisting of peroxymonosulfuric acids; perimidic acids; percabonic acids; percarboxilic acids and salts of said acids; preferably said percarboxilic acids and salts thereof comprise phthalimidoperoxyhexanoic acid (PAP), 1,12-diperoxydodecanedioic acid; or monoperoxyphthalic acid (magnesium salt hexahydrate); amidoperoxy acids, preferably said amidoperoxyacids comprises N,N′-terephthaloyl-di(6-aminocaproic acid), a monononylamide of either peroxysuccinic acid (NAPSA) or of peroxyadipic acid (NAPAA), N-nonanoylaminoperoxycaproic acid (NAPCA), and mixtures thereof; d) said diacyl peroxide comprises a material selected from the group consisting of dinonanoyl peroxide, didecanoyl peroxide, diundecanoyl peroxide, dilauroyl peroxide, dibenzoyl peroxide, di-(3,5,5-trimethyl hexanoyl) peroxide and mixtures thereof.

In another particularly preferred embodiment the benefit agent is a hydrogen peroxide source. Preferably, said hydrogen peroxide source comprises a material selected from the group consisting of a perborate, a percarbonate, a peroxyhydrate, a persulfate and mixtures thereof.

In one particularly preferred embodiment, the benefit agent is phthalimidoperoxyhexanoic acid (PAP).

In one particularly preferred embodiment, the benefit agent is sodium percarbonate.

In another preferred embodiment the benefit agent is an enzyme. Preferably, said enzyme comprises a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

In one highly particularly preferred embodiment, the benefit agent is selected from a lipase, protease, amylase, cellulase, pectatase, lyase, xyloglucanase and mixtures thereof.

In one preferred embodiment the benefit agent is a vitamin, essential oil, or other oil of nutritional benefit such as those from fish and vegetable sources. Suitable examples include marine oils (including “fish oils”) which are oils that are obtained from aquatic lifeforms, either directly or indirectly, particularly from oily fish. Marine oils include, for example, herring oil, cod oil, anchovy oil, tuna oil, sardine oil, menhaden oil and algae oil. Such oils may be desirable as sources of nutritive agents such as omega-3, omega-6 and omega-9 fatty acids docosapentaenoic acid, eicosatetraenoic acid, moroctic acid and heneicosapentenoic acid.

In another preferred embodiment the benefit agent is a drug or pro-drug.

In another preferred embodiment the benefit agent is an agent for the treatment of human skin such as one intended to treat acne (e.g. benzoyl peroxide) or the signs of aging (e.g. botulinum toxin).

In a further preferred embodiment the benefit agent is a biocide or bacteriostat for the cleaning and disinfection of manufacturing equipment.

In another preferred embodiment, the benefit agent is a herbicide, insecticide, fungicide, plant growth regulator, fertilizer or a mixture of the aforementioned benefit agents which may be used in agrochemical applications whereby an active is required to be kept in a stable condition until it is required for release upon application.

In one preferred embodiment, the benefit agent is in particulate form.

In another preferred embodiment, the benefit agent is in granulate form. For this embodiment, preferably the benefit agent is combined with a granulating polymer or binder.

The benefit agent may be processed to form core particles. This may be via granulation, compaction, pelletizing or extrusion and spheronisation. The benefit agent may be mixed with fillers, binders or disintegrants, or a mixture thereof. The benefit agent may also be mixed with further optional ingredients as desired. Fillers are selected upon their ability to absorb and retain water in order to achieve the optimal rheological conditions for lubrication and surface plasticization required during extrusion and spheronisation.

A non-limiting list of suitable fillers include, saccharides and their derivatives, disaccharides such as sucrose, polysaccharides and their derivatives such as cellulose or modified cellulose such as microcrystalline cellulose, sugars such as mannitol, cyclic oligosaccharides such as β-cyclodextrin and synthetic polymers such as polyvinylpyrrolidone (PVP) and crosspovidone (crosslinked PVP). Crosspovidone is particularly preferred. A particularly preferred source of crosspovidone is Kolloidon CL-M, a micronized product.

Binders may be used to ensure that the particles can be formed with the required mechanical strength of the end product. A non-limiting list of suitable binders include, anionic surfactants such as secondary alkyl sulfonate sodium salts, nonionic surfactants such as alcohol ethoxylates based on C12/C15 oxo alcohol, saturated fatty acids such as lauric acid, and synthetic polymers such as polyacrylate copolymers and poly(vinyl alcohol) (PVOH). Particularly preferred binders comprise the secondary alkyl sulfonate sodium salts, in particular Hostapur SAS from the group of anionic surfactants.

Any binders or fillers that are compatible with the bleaching materials may be used individually or in combination to form the particles of the present invention.

Additional ingredients may be added prior to particle formation to provide additional stability, for example chelating agents such as etidronic acid to bind metal ions that prove detrimental to the stability of the bleach material.

In one preferred embodiment, the consumer product comprises from about 0.001% to about 99%, preferably from about 1% to 60%, preferably from about 2% to about 30%, and more preferably from about 4% to about 15% of the coating described herein by weight of the total composition.

Description of Encapsulating Coating

It has been surprising found that a coating comprising a modified polymer—the reaction product of PVOH with certain amounts of butyraldehyde, and at least one salt or at least one surfactant or a mixture thereof can provide for an encapsulated particle, the core of which is a benefit agent, which is capable of retaining the activity of the core material, when formulated into a cleaning product such as a liquid or solid laundry product, for significantly longer timescales than for the core itself can retain without such coating.

Without being bound by theory it is believed that the presence of a salt within the coating acts upon the modified PVOH in such a way as to effectively reduce the solubility of the modified PVOH when in the presence of liquid formulations or when in the presence of moisture such as may be found in solid or powder formats where moisture ingress has occurred or humidity resulting from climatic conditions has ‘dampened’ the solid or powder. It is well known that many water-soluble polymers may be ‘salted-out’ by the addition of a suitable concentration of salt as the solubility of water soluble polymers is dependant, amongst other considerations, on the presence of intra and inter hydrogen bonding which is disrupted by the presence of charged species such as salts and can lead to the precipitation of the polymer as a fine, insoluble, powder. U.S. Pat. No. 5,429,874 by Vanputte discloses the use of salts in water soluble films which find utility in providing packaging protection to certain caustic materials.

In a similar fashion the presence of a surfactant, particularly a charged surfactant, can lead to the precipitation of water soluble polymer from solution if the concentration of the surfactant is of the correct concentration to produce such an effect. Additionally it is believed that the presence of an organic modification to the backbone of the water-soluble polymer, for example the incorporation of hydrophobic groups along the backbone, can give rise to an interaction of these hydrophobic groups with the hydrophobic parts of the surfactant and hence lead to an interaction which can reduce the solubility in water of the polymer when local surfactant levels are high.

Without being bound by theory it is believed that the presence of salt and optionally surfactant produces a responsive effect when water is present. The coating, immediately after manufacture, contains dry modified PVOH, salt and optionally surfactant. If, however, water is present in the bulk of the formulation, or in the case of a dry solid or powder, water is able to enter into the product then it is believed that the presence of salt and optionally surfactant in the presence of water produces an effect whereby the polymer increases its barrier to water as a result of the ‘in-solubilising’ effect that salt containing water has upon certain water soluble polymers. In effect the water provides mobility to the salt ions which are then able to act upon the water soluble polymer in such as way as to decrease its solubility in water and hence increase its barrier properties to water. This process provides for a coating which may be formed from a solution of water-soluble polymer and salt or surfactant or a mixture thereof. It is envisaged that the concentration of salt and/or surfactant is kept at such a level so as the polymer is still soluble in the solution, but may well be close to the point of insolubility. Upon formation of a coating, around the particle, and removal of water and/or any solvent present it will be clear to the person skilled in the art that the concentration of salt and/or surfactant, now in the form of a matrix within the polymeric coating film, is high and certainly high enough to maintain the insolubility of the polymer should any moisture of any kind permeate the coating.

Optionally the modified PVOH, salt and/or surfactant coating may be applied to a core particle which already has a coating layer applied. Such primary coating layer may be formed from a blend of wax, or wax like material, and an amphiphilic polymer. The following section details how such a blend may be prepared and how it may be applied to form a coating.

In a preferred embodiment the coating of modified PVOH, salt and/or surfactant may be applied to a core particle which is already primed with a coating formed from a blend of a wax, or wax like material and an amphiphilic polymer.

In a preferred embodiment the coating of modified PVOH, salt and/or surfactant may be applied as a primer to a core particle and a coating formed from a blend of a wax, or wax like material and an amphiphilic polymer may be applied on top of this primer coating.

Preparation of Blend

The wax or wax-like substance and the amphiphilic polymer may be blended together to form a homogenous mixture (i.e. a single phase blend) or they may be blended together to form a mixture of two or more phases. The phases present may be as a liquid in a solid or as a solid in a liquid or as a solid in a solid. Such blended materials may be produced by melting the two or more materials together to form a homogenous blend or, as described above, as a mixture of two or more phases.

Alternatively the two or more materials may be dissolved together to form a solution with any suitable solvent and then applied to the core by, for example, spray application or other suitable application method. Upon drying of this spray solution the blended mixture may then remain as a single phase dry coating or may phase separate to produce a dry coating which is multiphasic (two or more phases) as described above.

Alternatively a blended mixture of the wax or wax-like substance and the amphiphilic polymer may be produced by adding a solid material, such as a synthetic polymer, which has been finely ground (amphiphilic polymer) so as to produce a ‘slurry’ of the dry powdered polymer within the matrix of the wax or wax-like substance, which may be heated to produce a molten mixture, or the two materials (or more) may be added to each other using a suitable solvent to dissolve either the wax or wax-like substance, or both the amphiphilic polymer and the wax or wax-like substance. The polymer so added may not necessarily be a solid at room temperature and may well be a liquid or a viscous liquid and it may be mixed as described above either in the molten wax or wax-like substance, or in solution.

Coating Process—Wax/Amphiphilic Polymer Composite Layer

As described hereinbefore, the present invention also provides a process for preparing a composite as described herein, said process comprising the steps of:

(1) preparing one or more core units comprising at least one benefit agent;
(2) preparing a coating layer (B) comprising a blend comprising:
(i) a water-soluble polymer being a poly(vinyl alcohol) polymer modified by reaction with a 2-10C aldehyde, such that 1-15% of the available —OH groups have been modified; and
(ii) at least one ionic species;
   (3) optionally preparing a further coating layer (C) comprising a blend comprising:
(i) at least one wax or wax-like substance; and
(ii) at least one amphiphilic polymer;
   (4) applying coating layer (B) and optionally applying coating layer (C) to the core units to form a composite; and
   (5) drying the resulting particles to yield the composite.

Production of core particles may be carried out by any suitable means and the method is not critical to the invention save that the produced cores must be of sufficient mechanical strength to ensure that the particles are not damaged, broken up or otherwise degraded by the coating process employed.

Encapsulation may be carried out by any suitable means and the method is not critical to the invention. For example, the coating material may be sprayed on as a molten material or as a solution or dispersion in a solvent/carrier liquid which is subsequently removed by evaporation. The coating material can also be applied as a powder coating e.g. by electrostatic techniques, although this is less preferred as the adherence of powdered coating material is more difficult to achieve and can be more expensive. If layer coatings are applied in particle form (such as powders or dispersions), it may also be necessary to coalesce the particles which make up each layer in order to produce a layer which is sufficiently coherent, without appreciable levels of flaws such as cracks, holes or ‘flakiness’, to produce a sufficiently effective barrier.

Molten coating is a preferred technique for coating materials of melting point <80° C. but is less convenient for higher melting points (i.e. >100° C.). For coating materials of melting point >80° C., spraying on as a solution or dispersion is preferred. Organic solvents such as ethyl or isopropyl alcohol or chloroform can be used to form the solutions or dispersions depending on the nature and solubility of the solute, although this will necessitate a solvent recovery stage in order to make their use economic.

Application, in the case of waxes and/or other hydrophobic materials, from the molten state is particularly advantageous as this method allows for the potential for the direct application of up to 100% solids and avoids complications such as solvent recovery, allowing time for drying and the issues associated with the safe handling of volatile and potentially flammable solvents.

Application from solvent solution(s) is advantageous as the coating materials may be applied as a continuous and homogenous film from solvent solution. Any suitable solvent may be used accepting that consideration for volatility, boiling point, solubility of materials within the solvent, safety and commercial aspects is undertaken.

Solutions are particularly advantageous, where possible, provided the solution has a sufficiently low viscosity to enable it to be handled. Preferably a concentration of from about 5% to about 50% and preferably from about 10% to about 25% by weight of the coating material in the solvent is used in order to reduce the drying/evaporation load after surface treatment has taken place. The treatment apparatus can be any of those normally used for this purpose, such as inclined rotary pans, rotary drums and fluidised beds.

In one highly preferred embodiment, the coating is applied to the cores either by fluid bed coating or fluid bed drying. The composite material blend (e.g. of the wax or wax-like substance and the amphiphilic polymer) is applied to the core units from either the molten state or from solvent solution. It is preferable to apply aqueous dispersions (e.g. via an emulsion) of the composite blend to the core allowing that annealing may potentially be necessary to coalesce the dispersion particles into a continuous film. Suitable plasticisers may also be employed to produce continuous films. The polymer is preferably applied to the core units as either a solution from solvent or from an emulsion or latex. In one embodiment, where the polymer is applied as an alkaline coating solution such as for the application of a pH responsive polymer, preferably the solution further comprises a stabiliser, for example, ammonia. Aqueous alkaline solutions of the polymer are prepared by neutralisation of the acidic latex. Neutralisation with volatile amines, such as ammonia, trimethyl amine, triethyl amine, ethanolamine and dimethylethanolamine, are preferred as the volatile component is readily lost and a robust polymer coating is readily achieved. Typically neutralisation is accompanied by clarification of the coating mixture, from an opaque latex to a clear or hazy solution, and an increase in viscosity. Additional solvent may be added to reduce the polymer concentration and solution viscosity and so obtain a solution suitable for further processing.

In one highly preferred embodiment, the coating is applied from a dispersion (e.g. emulsion) of the wax or wax-like substance and the amphiphilic polymer and other optional ingredients including surfactants, plasticisers, cosolvents, fillers etc.

There are a number of different methods known in the art for making dispersions from waxes/polymers which may be utilised for the manufacture of aqueous dispersions used in this invention. In order for a dispersion to be stable it is necessary to control the particle size of the dispersed hydrophobic phase (e.g. the wax or wax like substance and/or amphiphilic polymer phase) in order to ensure that the dispersed phase does not settle out of suspension. To achieve this it is typically necessary to carefully control the method of addition of the hydrophobic material or blend (i.e. non-aqueous phase) to the water (or visa-versa) in the presence of chemical dispersants and/or surfactants whilst applying sufficient agitation/mechanical sheer to break up the oil phase. This hydrophobic phase may comprise the wax or wax like substance in the molten state and may also comprise a molten solution in combination with the amphiphilic polymer (e.g. the dispersion is hot and so the dispersed phase exists within the dispersion as liquid droplets). This hydrophobic phase may alternatively comprise the wax or wax like substance in the solid state and may also comprise a solid solution in combination with the amphiphilic polymer (e.g. the dispersion is cold, below the solidification point of the hydrophobic dispersed material and so will be a dispersion of solid particles). The amphiphilic polymer may be self dispersing meaning it is able to facilitate its emulsification and stabilisation in the water phase. Alternatively, if the polymer is not readily dispersible then surfactants may be required to disperse the polymer; these may be mixed into the oil phase prior to dispersion or may be present in the water phase prior to dispersion. It may also be necessary to include a plasticiser within the dispersion formulation so as to improve the coherency of the film which is produced from the coated emulsion. Typically materials which are solvents for the hydrophobic phase, such as chlorinated solvents, terpenes, hydrogenated rosin derivatives, hydrocarbon solvents or other substances which have at least a small solubility in the hydrophobic phase, are suitable. It should be recognised that, in the case of the amphiphilic substance, it may be present in both phases of the dispersion as it will have compatibility in both the hydrophobic and hydrophilic portions of the dispersion.

Generally, methods for creating dispersions may be divided into two processes. In the first of these, often referred to as the ‘direct method’, the hydrophobic phase is added in a controlled manner to the stirred aqueous phase resulting in the formation of dispersed particles in the water. An alternative method for manufacturing the dispersion is the inversion method, in which the aqueous phase is added to the hydrophobic phase. Initially the product of this process is the forced formation of an emulsion of water in the hydrophobic phase, however upon continued addition of the aqueous phase the system inverts to a dispersion of the hydrophobic phase in water.

Surfactants may be used in the manufacture of a dispersion to stabilise the colloidal dispersion of hydrophobic phase in water. In a preferred embodiment, one or more surfactants are added to either the aqueous or hydrophobic phase or both. In the case of the aqueous phase, the surfactant is typically dissolved in water prior to use. When added to the hydrophobic phase, the surfactant may be dissolved in any solvent present or may, for instance, be dissolved or dispersed into the molten wax or wax like substance.

A wide range of surfactants may be used, including non-ionic, anionic or cationic or zwitteronic (amphoteric) structures. The identity and chemistry of the surfactant used to stabilise the system is preferably selected to avoid incompatibility with the final formulation media.

In one highly preferred embodiment of the invention, cationic surfactants are used. These help to stabilise the formation of a stable dispersion, but once the core particles have been coated with the dispersion and the coated particles are then suspended in, for example, a laundry product containing anionic surfactant, the interaction between the cationic surfactants in the coating and the anionic surfactants in the media leads to the formation of an extra layer of this neutralised material and an increase in the barrier properties of the coating.

Conversely, in an alternative preferred embodiment of the invention, anionic surfactants are used. These help to stabilise the formation of a stable dispersion, but once the core particles have been coated with the dispersion and the coated particles are then suspended in, for example, a laundry product containing cationic surfactant the interaction between the anionic surfactants in the coating and the cationic surfactants in the media leads to the formation of an extra layer of this neutralised material and an increase in the barrier properties of the coating.

Other water soluble materials which behave as emulsifiers, such as poly(vinyl alcohol) or other water soluble polymers and non-ionic surfactants, may be used so as to produce a stable dispersion having small dispersed droplet size. Polymeric surfactants may also be used.

The addition of surfactants and/or emulsifiers to stabilise the dispersion may result in the entrapment of air and subsequent foaming which can interfere with efficient manufacture of the dispersion. Thus, in one particularly preferred embodiment, an anti-foaming agent is added to the aqueous and/or hydrophobic phase prior to dispersion manufacture in order to suppress the generation of foam.

In fluid bed coating the particulate core material is fluidised in a flow of hot air and the coating solution, melt, emulsion or latex sprayed onto the particles and dried, where the coating solution. Melt, emulsion or latex may be applied by top spray coating, bottom spray (Wurster) coating or tangential spray coating, where bottom spray (Wurster) coating is particularly effective in achieving a complete encapsulation of the core. In general, a small spray droplet size and a low viscosity spray medium promote uniform distribution of the coating over the particles.

In fluid bed drying the particulate core material is mixed with the coating solution, emulsion or latex and the resulting moist product introduced to the fluid bed dryer, where it is held in suspension in a flow of drying air, where it is dried or in the case of molten material is congealed. Such systems are available from several suppliers including GEA Process Engineering (Bochum, Germany) and Glatt Process Technology (Binzen, Germany).

It will be appreciated that any method which allows for the application of an essentially continuous film of material may be used to produce the layers described herein and that the processes described are illustrative and not exhaustive of methods, such as curtain coating, other forms of spray coating and any other suitable methods which is able to produce substantially the same particle layer structures described herein.

The results of the coating process are determined by the interaction of a combination of material and process parameters. In spray coating the following have been found to be important:
1. Composition and particle size distribution of the core.
2. The glass transition temperature of the polymer.
3. The solubility of materials within the chosen solvent.
4. Delivery of the composite blend of the wax or wax-like substance band the amphiphilic polymer as either a solution, dispersion or melt.
5. Delivery of the responsive polymer as either a solution, dispersion or a latex.
6. Delivery of primer and/or filler layers as either a solution, dispersion or a latex.
7. The solids content of the coating solution, dispersion, melt or latex.
8. The method of production of the emulsion such as the order of addition of the components and the chemical nature (cationic or anionic for example) of the components.
9. The dosing rate of the coating solution, dispersion, melt or latex to the fluidised bed.
10. The delivery of the coating solution, dispersion, melt or latex by bottom spray (Wurster) or top spray.
11. The mass of polymer applied per unit mass of the core.
12. The mass of the composite blend material applied per unit mass of the core.
13. The inlet temperature of the air maintaining the fluidised bed.
14. The difference between the polymer's glass transition temperature and inlet air temperature of the air flow maintaining the fluidised bed.

The present invention is further described by way of the following non-limiting examples.

Description of Particle Formation and Coating Process

The core units may be prepared by co-agglomerating a granulating or binding agent with the benefit agent in order to produce suitably sized particle cores prior to coating the core units with the layers composing the composite material comprising polymer, salt, optionally surfactant and optionally primer and/or filler components and/or layers and, optionally, the wax/amphiphilic copolymer composite layer.

A preferred size for such coated particles is between 0.25 to 5 mm, most preferably between 0.5 mm to 2.5 mm with a coating of 1 to 99% preferably 10 to 50% based on total mass of the particle including coating.

In one preferred embodiment, the core units are prepared by extrusion of narrow columnar ‘noodles’ of the benefit agent which may then be spheronised or Marumerised in order to produce suitably sized particle cores prior to coating the core units.

Production of core particles may be carried out by any suitable means and the method is not critical to the invention save that the produced cores must be of sufficient mechanical strength to ensure that the particles are not damaged, broken up or otherwise degraded by the coating process employed.

Spraying on the coating(s) as an aqueous solution or dispersion in water is preferred. Organic solvents such as ethyl or isopropyl alcohol or chloroform may be used to form the solutions or dispersions depending on the nature and solubility of the solute, although this will necessitate a solvent recovery stage in order to make their use safe and economic.

In one highly preferred embodiment, the coating is applied to the cores either by fluid bed coating or fluid bed drying. The coating is preferably applied to the core units as either a solution from solvent, including an aqueous solvent or from an emulsion or latex.

In one highly preferred embodiment, the coating is applied from an aqueous solution and may include other optional ingredients including salts, surfactants, plasticisers, cosolvents, fillers etc.

In fluid bed coating the particulate core material is fluidised in a flow of hot air and the coating solution, melt, emulsion or latex sprayed onto the particles and dried, where the coating solution. melt, emulsion or latex may be applied by top spray coating, bottom spray (Wurster) coating or tangential spray coating, where bottom spray (Wurster) coating is particularly effective in achieving a complete encapsulation of the core. In general, a small spray droplet size and a low viscosity spray medium promote uniform distribution of the coating over the particles. Such systems are available from several suppliers including GEA Process Engineering (Bochum, Germany) and Glatt Process Technology (Binzen, Germany).

It will be appreciated that any method which allows for the application of an essentially continuous film of material may be used to produce the layers described herein and that the processes described are illustrative and not exhaustive of methods, such as curtain coating, other forms of spray coating and any other suitable methods which is able to produce substantially the same particle layer structures described herein.

Consumer Product

Another aspect of the invention relates to a consumer product comprising a composite as described above. The consumer product may be a product for the care of homes, businesses or institutions for instance in laundry or dishwash products and detergents, particularly preferably liquid detergents. Other preferred examples of consumer products include personal care and cosmetic formulations, surface cleaning formulations, pharmaceutical, veterinary, food, vitamin, mineral and nutritional compositions. Further preferred examples include compositions for use in agriculture and a range of industries including mining and manufacturing, for instance in the production of food, flavours, fragrances and beverages or for use in areas such as lubrication aids, oil field technology, fuel additives, dyes and pigment technology, laundry softening—including laundry actives and polymeric ingredients—textile lubricants, softening agents, enzymes, whitening agents and shading dyes.

Consumer products include those relating to baby care, beauty care, fabric and home care, family care, feminine care, or devices generally intended to be used in the form in which it is sold. Such products include, but are not limited to, diapers, bibs, wipes; products for and/or methods relating to treating hair (human, dog, and/or cat), including, bleaching, colouring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; vitamin products: including tablets, soft and hard capsules, gel and liquid formats and containing vitamins or other benefit agents which require stabilisation due to adverse interaction with other formulation ingredients or natural processes such as instability to oxidation; agrochemical products which include: products or formulations containing herbicides, fungicide, insecticides, plant or insect hormones or growth regulators or fertilizers such products requiring stabilisation of the benefit agent to prevent degradation of the benefit agent due to negative interactions with formulation ingredients or to prevent degradation due to adverse chemical reactions which result in a reduction of activity of the benefit agent over time when in formulation; pharmaceutical products, whereby a benefit agent may require stabilisation in order to avoid degradation caused by adverse interactions with other formulation ingredients or to prevent degradation from chemical reactions such as, for example, oxidation. Pharmaceutical product formats may take the form of powders, granules, capsules both hard and soft, such capsules may even be engineered to release at a particular location with the human body such as, for example, an enteric polymer capsule designed to survive the environment of the stomach and to be able to release within the gut. Other formats may include liquids, gels or pastes; Veterinary products whereby benefit agents may be protected from adverse reactions with other formulation ingredients to provide stable products which are able to deliver activity during application usage. Veterinary Product formats may take the form of powders, granules, capsules both hard and soft, such capsules may even be engineered to release at a particular location with the body such as, for example, an enteric polymer capsule designed to survive the environment of the stomach and to be able to release within the gut. Other formats may include liquids, gels or pastes.

In one preferred embodiment, the consumer product is a cleaning and/or treatment composition. As used herein, the term “cleaning and/or treatment composition” is a subset of consumer products that includes, unless otherwise indicated, beauty care, fabric and home care products. Such products include, but are not limited to, products for treating hair (human, dog, and/or cat), including, bleaching, colouring, dyeing, conditioning, shampooing, styling; deodorants and antiperspirants; personal cleansing; cosmetics; skin care including application of creams, lotions, and other topically applied products for consumer use including fine fragrances and shaving products, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, including those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

In one highly preferred embodiment, the consumer product is a laundry product either as a liquid format or as a solid, powder, granular, bar and tablet format.

In another preferred embodiment, the consumer product is a fabric and/or hard surface cleaning and/or treatment composition. As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, including those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

In a preferred embodiment of the invention the composite of the invention is suitable for inclusion in a liquid or powder/solid consumer product as a coated material, the coating of which is readily soluble or dispersible in the application environment, whereupon the benefit agent(s) will be released.

Particular embodiments of the invention are described in the following numbered paragraphs:

1. A composite comprising at least one benefit agent, and a blend comprising:
(i) at least one water soluble polymer; and
(ii) at least one salt, or at least one surfactant, or a mixture thereof;
(iii) optionally at least one wax or wax-like substance; and
(iv) optionally at least one amphiphilic polymer.
2. A composite according to paragraph 1 which is in the form of a matrix particle.
3. A composite according to paragraph 2 wherein the matrix particle is coated by a blend comprising:
(i) at least one water soluble polymer; and
(ii) at least one salt, or at least one surfactant, or a mixture thereof.
4. A composite according to paragraph 2 or paragraph 3 wherein the matrix particle is coated by a coating layer (C) comprising a blend comprising:
(i) at least one wax or wax-like substance; and
(ii) at least one amphiphilic polymer.
5. A composite according to paragraph 1 which is in the form of:
(a) one or more core units (A) comprising the at least one benefit agent; and
(b) a coating layer (B) on said one or more core units, wherein said coating layer (B) comprises a blend comprising:
   (i) at least one water soluble polymer; and
   (ii) at least one salt, or at least one surfactant, or a mixture thereof;
(c) optionally a further coating layer (C) comprising a blend comprising:
   (i) at least one wax or wax-like substance; and
   (ii) at least one amphiphilic polymer.
      6. A composite according to paragraph 5 wherein coating layer (B) comprises a blend comprising at least one water soluble polymer and at least one salt.
      7. A composite according to paragraph 5 wherein coating layer (B) comprises a blend comprising at least one water soluble polymer and at least one surfactant.
      8. A composite according to paragraph 5 wherein coating layer (B) comprises a blend comprising at least one water soluble polymer, at least one salt and at least one surfactant.
      9. A composite according to any preceding paragraph wherein the water soluble polymer comprises a homopolymer or copolymer of vinyl alcohol.
      10. A composite according to any preceding paragraph wherein the water soluble polymer comprises a copolymer of vinyl alcohol and an olefin.
      11. A composite according to any one of paragraphs 1 to 9 wherein the water soluble polymer comprises a copolymer of vinyl alcohol and an acrylic or methacrylic monomer.
      12. A composite according to any one of paragraphs 1 to 8 wherein the water soluble polymer comprises a modified poly(vinyl alcohol).
      13. A composite according to paragraph 12 wherein the water soluble polymer comprises butyraldehyde modified PVOH (PVB).
      14. A composite according to any preceding paragraphs wherein the salt is selected from a halide, silicate, sulfate, citrate, carbonate, phosphate of the alkali or alkali earth metals, or is an ammonium/alkyl ammonium salt forming cation.
      15. A composite according to paragraph 14 wherein the salt is selected from sodium chloride, magnesium sulfate, sodium sulphate, aluminium chloride and aluminium sulfate
      16. A composite according to any preceding paragraph wherein the surfactant is an anionic surfactant or a non-ionic surfactant.
      17. A composite according to paragraph 16 wherein the surfactant is selected from alkyl benzene sulfonates, alkyl sulfates, alkyl alkoxy sulfates, alkyl ethoxylates and alkylphenol ethoxylates.
      18. A composite according to paragraph 16 wherein the surfactant is selected from sodium dodecylbenzene sulfonate (SDBS), sodium dodecyl sulfonate and sodium laureth sulphate.
      19. A composite according to any preceding paragraph wherein the benefit agent is selected from a bleach, a bleach activating agent, a preformed peracid, a bleach booster, a diacyl peroxide, a hydrogen peroxide source, a metal catalyst or pro-catalyst, an enzyme, a drug, a pro-drug, a vitamin, a pro-vitamin, an essential oil, a fish oil, a lubricant, a flavour and a fragrance.
      20. A composite according to any preceding paragraph which comprises a further coating layer (C) as defined in claim 5.
      21. A composite according to paragraph 20 wherein the further coating layer (C) is positioned between the core unit and the coating layer (B).
      22. A composite according to any preceding paragraph wherein the wax is a natural wax selected from beeswax, candelilla wax, carnauba wax, a paraffin wax, ozokerite wax, ceresine wax, montan wax, terpenes, camphor and mixtures thereof, or a synthetic, linear or branched wax selected from a petroleum-derived microcrystalline wax, a polyolefin wax and a polyethylene-derived wax, and mixtures thereof.
      23. A composite according to any preceding paragraph wherein the amphiphilic polymer is a graft copolymer comprising a hydrophobic straight or branched chain carbon-carbon backbone having at least one hydrophilic side chain attached thereto.
      24. A composite according to paragraph 23 wherein the hydrophilic side chains of the graft copolymer are each independently of formula (I),

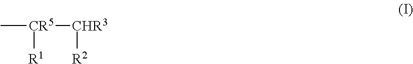

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

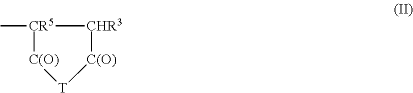

wherein:

R³ and R⁵ are each independently H or alkyl;

W is O or NR⁴;

Q is a group of formula —X¹—Y—X²P;

T is a group of formula —N—Y—X²—P;

X¹ is O, S or NR⁴;

X² is O, S, (CH₂)ₚ or NR⁴;

p is 0 to 6;

each R⁴ is independently H or alkyl;

P is H or another backbone; and

Y is a hydrophilic polymeric group.

25. A composite according to paragraph 24 wherein the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum b+c has a value in the range of from about 10 to about 250, more preferably, from about 10 to about 120.
26. A composite according to paragraph 23 wherein the graft copolymer has from 1 to 5000, preferably from about 1 to about 300, and more preferably from about 1 to about 150, pendant hydrophilic groups attached thereto.
27. A composite according to paragraph 23 wherein the carbon-carbon polymer backbone is derived from a homopolymer of an ethylenically-unsaturated polymerizable hydrocarbon monomer or from a copolymer of two or more ethylenically-unsaturated polymerizable hydrocarbon monomers.
28. A composite according to paragraph 27 wherein the copolymer comprises a carbon-carbon backbone onto which maleic anhydride or maleic anhydride acid/ester groups have been grafted.
29. A composite according to any one of paragraphs 23 to 28 wherein the carbon-carbon polymer backbone is polybutadiene-graft-maleic anhydride and the hydrophilic side chains of the graft are prepared from a side chain precursor of formula (VIc),

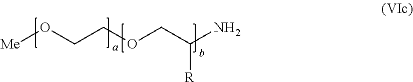

wherein R is H or alkyl, and the sum of a and b is an integer from 5 to 250.
30. A composite according to paragraph 23 wherein the carbon-carbon backbone is a copolymer of:
(i) maleic anhydride, maleic acid or salts thereof or maleic acid ester or salts thereof or a mixture thereof; and
(ii) one or more ethylenically-unsaturated polymerizable monomers.
   31. A composite according to any one of paragraphs 1 to 30 wherein the amphiphilic polymer is a block copolymer of ethylene and ethylene oxide.
   32. A composite according to any preceding paragraph wherein the composite comprises one or more additional coating layers selected from a primer layer, a filler layer, a layer of an inorganic material, an adhesion promoting layer or a de-tacifying layer.
   33. A process for preparing a composite according to any one of paragraphs 5 to 32, said process comprising the steps of:
(1) preparing one or more core units comprising at least one benefit agent;
(2) preparing a coating layer (B) comprising a blend comprising:
   (i) at least one water soluble polymer; and
   (ii) at least one salt, or at least one surfactant, or a mixture thereof;
(3) optionally preparing a further coating layer (C) comprising a blend comprising:
   at least one wax or wax-like substance; and
   (ii) at least one amphiphilic polymer; and
(4) applying coating layer (B) and optionally applying coating layer (C) to the core units to form a composite.
   34. A process according to paragraph 33 which comprises the steps of applying coating layer (C) to the one or more core units prepared in step (1) to form one of more coated core units; and then applying coating layer (B) to said one or more coated core units to form a composite.
   35. A consumer product comprising a composite according to any one of paragraphs 1 to 32.
   36. A consumer product according to paragraph 35 which is selected from laundry products, dishwash products, personal care and cosmetic formulations, surface cleaning formulations, pharmaceutical, veterinary, food, vitamin, mineral and nutritional compositions.
   37. A consumer product according to paragraph 35 or 36 which is a liquid laundry product.
   38. Use of a composite according to any one of paragraphs 1 to 32, or a process according to claim 33 or 34, in the preparation of a consumer product.
   39. A method of preparing a laundry product, said method comprising admixing a composite according to any one of paragraphs 1 to 32 with one or more conventional laundry product components.
   40. Use of a composite according to any one of paragraphs 1 to 32 as an additive in a laundry product.
   41. Use of a blend comprising:
   (i) at least one water soluble polymer; and
   (ii) at least one salt, or at least one surfactant, or a mixture thereof;
   as a phlegmatizer.
   42. Use of a blend comprising:
   (i) at least one water soluble polymer; and
   (ii) at least one salt, or at least one surfactant, or a mixture thereof;
   to stabilise or desensitise a benefit against undesired overheating.
   43. Use according to paragraph 41 or paragraph 42 wherein the blend is admixed with a composite comprising at least one benefit agent.
   44. Use according to paragraph 41 or paragraph 42 wherein the blend is coated onto one or more core units comprising at least one benefit agent.
   45. A composite, process, consumer product, method or use substantially as described herein with reference to the accompanying examples.

The present invention is further described by way of the following non-limiting examples.

### EXAMPLES

### Synthesis Example 1: Preparation of Butyl-Modified Mowiol 10-98 at 8% (Degree of Substitution—DS) with Butyraldehyde (PVB)

A 2-litre reaction vessel was charged with Mowiol 10-98 (100 g) and de-ionised water (900 g). The reaction vessel was placed onto a heating block and fitted with a head unit, anchor stirrer, nitrogen line, condenser and bubbler. The mixture was then heated to 80° C. and stirred under nitrogen for 1 hour or until all Mowiol had dissolved. After this time, the temperature of the heating block was reduced to 60° C. and 2M HCl (13.4 mL, 27 mmol) was added followed by butyraldehyde (6.42 g, 89 mmol). Stirring was continued at 60° C. After this time the heating block was turned off and the mixture was stirred overnight at room temperature. After this time, the reaction mixture was neutralised to pH 7 using dilute ammonia solution and the reaction product was precipitated by dropwise addition of the reaction mixture to an excess of acetone (4 litres total). The precipitate was then filtered off and dried in a vacuum oven at 40° C. overnight.

It is also possible to use the reaction mixture directly, optionally after neutralisation of the excess HCl with a suitable alkali such as sodium hydroxide. The reaction mixture may be diluted down to a suitable viscosity to enable, for example, spraying coating and further optional components may be added such as inorganic salts or surfactants or other as described herein.

### Amphiphilic Graft Co-Polymer Synthesis Examples

### Synthesis Example 2: Reaction of Polybutadiene-Graft-Maleic Anhydride Lithene N4-5000-5MA Grade with Jeffamine M2070 (Preparation of AGC1) in a Reaction Flask

PBD-g-MA (200 g, Polybutadiene-graft-maleic anhydride obtained from Synthomer, Lithene N4-5000-5MA grade) having an average molecular weight of approximately 5,750 Da was weighed out and added to a reaction flask with a 0.5 L capacity, equipped with an overhead stirrer. A flow of nitrogen gas was passed through the vessel, which was then heated to 150° C. using an oil bath. Stirring of the molten mixture then commenced and Jeffamine M2070 (Polyether monoamine) (144 g, purchased from Huntsman), having an average molecular weight of 2,000 Da was added over 45 minutes via a dropping funnel. The reaction mixture was maintained at 150° C. for a total of approximately 6 hours with stirring. Following this it was allowed to cool and was then dispensed into a glass container.

### Synthesis Example 3: Reaction of Polybutadiene-Graft-Maleic Anhydride Lithene N4-5000-15MA Grade with Jeffamine M2070 (Preparation of AGC2)

PBD-g-MA (200 g, Polybutadiene-graft-maleic anhydride obtained from Synthomer, Lithene N4-5000-15MA grade) having an average molecular weight of approximately 5,750 Da was weighed out and added to a reaction flask with a 1.0 L capacity, equipped with an overhead stirrer. A flow of nitrogen gas was passed through the vessel, which was then heated to 150° C. using an oil bath. Stirring of the molten mixture then commenced and Jeffamine M2070 (Polyether monoamine) (401.1 g, purchased from Huntsman), having an average molecular weight of 2,000 Da was added over 45 minutes through a dropping funnel. The reaction mixture was maintained at 150° C. for a total of approximately 6 hours with stirring. Following this it was allowed to cool and was then dispensed into a glass container.

### Particle Manufacture and Coating Method Examples

Preparation of Coated Sodium Percarbonate Particles

Materials

Samples of sodium percarbonate granules were sourced from several suppliers; Evonik Industries grade Q35 and Solvay Chemicals grades—Oxyper S131 and Oxyper SHC; OCI Chemical Corporation-Provox and Provox C grades.

The composition of the feedstock preparation is shown in Table 1.

### Example SPC Sample—Small Scale SPC/PVB/S1

Modified PVOH Coating Application

Particles of sodium percarbonate (grade S131) were sourced from Solvay. The particles were sieved to isolate the size fraction between 500-1,000 microns. The particles were coated on a Mini-Glatt fluid bed dryer utilising a bottom coating (Wurster) method. The typical temperature applied was 23-24° C. The airflow varied from 0.35 bar to 0.6 bar and the atomising pressure was kept to 0.03 bar. The feedstock was composed of the reaction mixture as prepared above in Synthesis Example 1 and formulated as shown in Table 1. A typical scale for this apparatus could be between 50 g to 100 g and a typical coating thickness based on w/w coating/particle core was 5.0%

### Example SPC Sample—Larger Scale SPC/PVB/S2

Modified PVOH Coating Application

Particles of sodium percarbonate (grade S131) were sourced from Solvay. The particles were sieved so as to isolate the size fraction between 500-1,000 microns. The particles were coated on an Aeromatic Fielder Strea 1 fluid bed dryer utilising a bottom coating (Wurster) method. The feedstock was composed of the reaction mixture as prepared above in Synthesis Example 1 and formulated as shown in Table 1. The typical operating temperature varied from 30-42° C. The airflow was varied from 100-130 m³/hr and the atomising pressure was kept at 0.5 bar. The polymer/salt solution was fed using a peristaltic pump and the flow rate varied from 6 to 8 g/min. A typical scale for this process was 500 g and a typical coating thickness based on w/w coating/particle core was 5.0%

Preparation of Wax/Amphiphilic Copolymer Coated Particles

(i) Feedstock Preparation

The feedstock containing wax and amphiphilic copolymer may, as described earlier, be in the form of a homogenous solution, such as a solvent containing solution, or, it may be in the form of a melt, or, it may be in the form of a dispersion or emulsion. Herewith examples are given whereby sodium percarbonate cores were coated with an emulsion or chloroform solution containing a blend of Vybar 260 (manufactured by Baker Hughes) and an amphiphilic graft co-polymer or alternatively from a chloroform solution. The amphiphilic co-polymer is composed of a polybutadiene backbone (manufactured by. Synthomer: Lithene N4-5000-15MA) which has been grafted with Jeffamine M2070 (manufactured by Huntsman) with a MA:Graft ratio of 1:0.75 (see Synthetic Example 3 above). This amphiphilic graft co-polymer produced as above was labelled AGC2.

An emulsion of Vybar 260 and Jeffamine M2070 grafted Lithene N4-5000-15MA was produced using the following method. A dispersion was prepared as follows. 1.5 g of AGC2 was dissolved in 190 g of deionised water with stirring. 8.5 g of Vybar 260 was added to the solution. The solution was heated to 65° C. for approximately 20 minutes with stirring or until the Vybar was completely molten. The warm mixture was then sonicated with a sonic probe for up to 10 minutes, creating an emulsion. The emulsion was cooled immediately on an ice/water bath swirling the emulsion occasionally. The emulsion was stirred throughout the spray coating process (coating process as described above for solvent based solutions). It should be understood that other methods for producing emulsions are possible and the skilled operator will be familiar with these procedures.

Materials

Samples of sodium percarbonate granules were sourced from several suppliers; Evonik Industries grade Q35, OCI Chemical Corporation's Grade C Provox, and Solvay Chemicals' grades, Oxyper S131 and Oxyper SHC.

Small Scale SPC Sample

Wax/Amphiphilic Layer Coating Application:

Particles of sodium percarbonate (grade S131) were sourced from Solvay. The particles were sieved so as to isolate the size fraction between 500-1,000 microns. The particles were coated on a Mini-Glatt fluid bed dryer utilising a bottom coating (Wurster) method. The concentration of the feed was typically 5% solids contents. The typical temperature applied was 23-24° C. The airflow varied from 0.35 bar to 0.6 bar and the atomising pressure was kept to 0.03 bar. The feedstock was composed of a 85:15 mixture of Vybar 260 (Baker Petrolite) and AGC2 (see synthesis example 3 above) dissolved in chloroform to a total concentration of 5% which was fed by peristaltic pump; the flow rate varied from 5 to 7 g/min until typically a 20% w/w of wax/amphiphilic copolymer coating is applied. A typical scale for this process was 50-100 g. Please note this coating may also be applied from an emulsion feedstock prepared as described above—a general method is as follows: sodium percarbonate cores were coated with a blend of Vybar 260 (ex. Baker Hughes) and an amphiphilic graft co-polymer. The amphiphilic co-polymer is composed of a polybutadiene backbone (ex. Synthomer: Lithene N4-5000-15MA) which has been grafted with Jeffamine M2070 (ex. Huntsman) with a MA:Graft ratio of 1:0.75 (see Synthetic Example 3 above). This amphiphilic graft co-polymer produced as above was labelled AGC2. An emulsion of Vybar 260 and Jeffamine M2070 grafted Lithene N4-5000-15MA was produced using the following method. A dispersion was prepared as follows. 1.5 g of AGC2 was dissolved in 190 g of deionised water with stirring. 8.5 g of Vybar 260 was added to the solution. The solution was heated to 65° C. for approximately 20 minutes with stirring or until the Vybar was completely molten. The warm mixture was then sonicated with a sonic probe for up to 10 minutes, creating an emulsion. The emulsion was cooled immediately on an ice/water bath swirling the emulsion occasionally. The emulsion was stirred throughout the spray coating process (coating process as described above for solvent based solutions).

Modified PVOH/NaCl Layer Application Upon the Wax/Amphiphilic Layer:

The wax/amphiphilic copolymer coated particles so prepared were further coated on a Mini-Glatt fluid bed dryer utilising a bottom coating (Wurster) method. The typical temperature applied was 23-24° C. The airflow varied from 0.35 bar to 0.6 bar and the atomising pressure was kept to 0.03 bar. The feedstock was composed of the reaction mixture as prepared above in Synthesis Example 1 and formulated as shown in Table 1. A typical coating thickness based on w/w coating/particle core was 5.0% in order to produce coated particles having, in this case, two coating layers, to which the layer applied also comprises modified PVOH, salt and optionally surfactant.

Larger Scale SPC Sample

Wax/Amphiphilic Layer Coating Application:

Particles of sodium percarbonate (grade S131) were sourced from Solvay. The particles were sieved so as to isolate the size fraction between 500-1,000 microns. The particles were coated on an Aeromatic Fielder Strea 1 fluid bed dryer utilising a bottom coating (Wurster) method. The feedstock was composed of a 85:15 mixture of Vybar 260 (Baker Petrolite) and AGC2 (see synthesis example 3 above) dissolved in chloroform to a total concentration of 5%. The concentration of the polymer feed was typically 5% solids content. The typical operating temperature varied from 30-42° C. The airflow was varied from 3 to 5% and the atomising pressure was kept at 0.5 bar. The polymer solution was fed using a peristaltic pump and the flow rate varied from 6 to 8 g/min until typically a 20% w/w of wax/amphiphilic copolymer coating is applied. A typical scale for this process was 500 g. Please note that this coating may also be applied from an emulsion prepared as described above.

Modified PVOH/NaCl Layer Application Upon the Wax/Amphiphilic Layer:

The wax/amphiphilic copolymer coated particles so prepared were further coated on an Aeromatic Fielder Strea 1 fluid bed dryer utilising a bottom coating (Wurster) method. The feedstock was composed of the reaction mixture as prepared above in Synthesis Example 1 and formulated as shown in Table 1. The typical operating temperature varied from 30-42° C. The airflow was varied from 100-130 m³/hr and the atomising pressure was kept at 0.5 bar. The polymer/salt solution was fed using a peristaltic pump and the flow rate varied from 6 to 8 g/min. A typical coating thickness based on w/w coating/particle core was 5.0% in order to produce coated particles having, in this case, two coating layers, to which the layer applied also comprises modified PVOH, salt and optionally surfactant.

Preparation of PAP Samples

The process of preparing and coating the PAP bleach-containing particles was performed via the following processes.
1. Preparation of a wet-mass
2. Extrusion of the wet mass
3. Shaping of the wet mass such as by chopping or spheronisation of the wet mass
4. Drying and coating of the wet mass.

Components, Abbreviations and Sources of Materials

Eureco WM1—6-phthalimidoperoxyhexanoic acid (PAP)—Solvay; potato starch—Aldrich Chemical Co citric acid (anhydrous)—Aldrich Chemical Co, etidronic acid—1-hydroxy-ethylene-1,1-diphosphoric acid (HEDP)-; Hostapur SAS (93)—Clariant; Formation of the wet mass was performed on a food grade Kenwood FPP220 Multipro Compact mixer the extrusion was perfumed on a Caleva Variable Density Extruder with a 0.7 mm diameter hole die plate. The spheronisation was performed on a Caleva Multi Bowl Spheroniser 250 (MBS250). Drying of the particles was performed on an Aeromatic Fielder Strea 1 and coating of the dried particles was conducted on Glatt (Mini Glatt 5) for small scale coating and on the Strea for larger samples.

### Example PAP1—Preparation of a Spheronised PAP-Core

Preparation of the Binder Fluid

Hostapur® SAS 93 (150 g) was added to deionised water (200 g) and stirred with heating to 60° C. until the Hostapur® had dissolved. The sample was then cooled to room temperature.

Preparation of the Wet Mass

Eureco WM1 (323.33 g) (previously sieved to less than 250 μm) was weighed into the bowl of a Kenwood mixer to this was added Potato Starch (27.39 g) and anhydrous citric acid (10.85 g). The powder mixture was blended at the highest speed setting for 5-10 seconds to ensure a homogenous powder mixture. Following this, etidronic acid (60% solution) (4.81 g) was added drop-wise whilst mixing the powders. The previously prepared binder fluid (approx 83 g) was then added at a constant rate over 5-10 seconds whilst mixing. The binder fluid was added until a change in pitch of the mixing sound occurred, at this point the dough formed a breadcrumb-like appearance, and the total binder addition was recorded. The sides of the bowl were then scraped with a plastic spatula and the sample was then mixed for a further 10 seconds.

Extrusion of the Wet Mass

The prepared wet-dough was then added to the extruder and extruded at room temperature using a screw speed of 50 rpm. The extruded noodles were then retained for subsequent spheronisation.

Spheronisation of the Extrudate

Spheronisation took place at a plate rotation speed of 1500 rpm. The prepared extrudate was added to the spheroniser for 3 minutes at which point the particles generated were of an acceptable spherical form.

Drying of the Product

The resultant spheronised particles were dried in the fluid bed drier at 40° C. for 1 hour 10 mins at an air flow rate which ensured good fluidisation of the sample, to ensure the majority of the moisture was removed from the particles. An additional drying step was performed where the product was dried in a vacuum oven at 35° C. for 18 hours.

Coating of the Materials

A particularly useful class of materials which can be used to coat the pre-formed PAP-containing particles are functionalised or un-functionalised poly(vinyl alcohols -co-vinyl acetate) such as those provided by the Kuraray Co Ltd such as the Mowiol® series of materials. These materials have the general nomenclature Mowiol® X-Y where the value for X represent the viscosity (in mPas) of a 4% aqueous solution of the polymer at 4% w/w solids and Y represents the molar % hydrolysis of the starting poly(vinyl acetate). Coating methods are given above in C1(i) and C1(ii), save for replacement of SPC with the PAP particles.

Screening of Prepared Samples

SPC

Peroxide determination was by titration using the following method:

Methodology of Testing in Liquid Laundry Formulation

Equipment & Materials:
1. 5 mL small plastic tubes.
2. Small squares of filter mesh.
3. Coated SPC particles.
4. Analytical balance
5. Reagents and glassware—as per detailed titrimetric procedure.
6. Deionised water.
7. Nylon filter mesh to form bags in which the SPC particles are placed during the stability test

Methodology (Liquid Media)
1. Sample preparation.
   a. The plastic tubes were filled with the particular media (5 mL)
   b. 0.2 g (actual mass recorded) of coated particles were weighed and placed into folded filter mesh.
   c. The rolled filter mesh was placed into the tubes previously filled with the detergent.
   d. The tubes were sealed.
   e. Prepared samples were aged for the required amount of time at controlled temperature.
2. Recovery of the particles after testing in laundry liquid (centrifugation).
   a. After storage the filter sock was removed, containing the particles, and the excess detergent media was wiped off with tissue.
   b. The recovered particles were placed into 100 mL volumetric flasks. The titrimetric analysis described below was performed.
3. Titrimetric analysis of recovered sodium percarbonate encapsulates.
   This method is essentially a 2 step reaction; in the first step, hydrogen peroxide oxidises iodide ions producing elemental iodine as follows:

H₂O₂+2H⁺+2I⁻→I₂+2H₂O
The second step in the titration the iodine is reduced by sodium thiosulfsulfate (Na₂S₂O₃) as follows:

I₂+2S₂O₃²⁻→S₄O₆²⁻+2I⁻
This method is more suited to assessing the hydrogen peroxide content of formulations in which sodium percarbonate was used as a bleach source. The procedure is as follows:
a. A solution of 5 mL H₂SO₄ (10%) and 30 mL deionised water was added to a 100 mL volumetric flask.
b. 0.2 g of the recovered particles from storage stability testing was placed into the hydrogen peroxide solution.).
c. The mixture was stirred using a magnetic stirrer until the particles were completely dissolved.
d. Once completely dissolved, the flask was topped up to the 100 mL mark using deionised water. The flask was stoppered and inverted at least 10 times to ensure the solution was properly mixed.
e. To 5 mL of this solution was added 2.5 mL H₂SO₄ (10% w/w) and 2.5 mL of KI solution (20% w/w).
f. The solution was left in a dark room for at least 20 minutes.
g. This solution was titrated against a solution of sodium thiosulfsulfate (0.1N) until the solution became completely colourless.
h. The volume of Sodium Thiosulfsulfate required to produce a clear solution was recorded.
i. The process was repeated until concordant results were obtained.
4. Calculation of final storage stability of SPC encapsulates.
   a. An average of the sample masses and titre values for the 2 different samples of the same formulation was taken. Using the following equations a value for the percentage sodium percarbonate remaining in the solution was obtained:

$$\% Active Oxygen = \frac{1.6 * titre value}{Sample Mass}$$

$$\% Sodium Carbonate = \frac{\% Active Oxygen}{0.13}$$

The results are shown in Table 2. Table 2 presents data which shows that coated cores of sodium percarbonate grades sourced from different manufacturers demonstrated significantly improved stability over time (measured at 28 days) and at elevated temperatures when compared to uncoated cores which have been tested under the same stability testing conditions.

Methodology of Testing in Powder Laundry Formulation

Equipment & Materials:
1. 5 mL small plastic tubes.
2. Small squares of filter mesh.
3. Coated SPC particles.
4. Analytical balance
5. Reagents and glassware—as per detailed titrimetric procedure.
6. Deionised water.

Method
1. Sample preparation.
   a. The tubes were filled with the required weight of powder detergent (0.2 g of SPC should make 15% of powder weight)
   b. 0.2 g of coated particles were weighed and placed into powder filled tubes. The weight was recorded.
   c. The tubes were sealed for ‘closed’ stability, or left open when test is done under a relative humidity.
   d. Prepared samples were aged for the fixed amount of time at controlled temperature and humidity.
2. Recovery of the particles after testing in laundry liquid (centrifugation).
   a. The entire sample (powder with SPC) was placed into a 100 mL volumetric flask. And the titrimetric analysis performed.
3. Titrimetric analysis of recovered sodium percarbonate encapsulates.
   This method is essentially a 2 step reaction; in the first step, hydrogen peroxide oxidises iodide ions producing elemental iodine as follows:

H₂O₂+2H⁺+2I⁻→I₂+2H₂O
The second step in the titration the iodine is reduced by sodium thiosulfsulfate (Na₂S₂O₃) as follows:

I₂+2S₂O₃²⁻→S₄O₆²⁻+2I⁻
This method is more suited to assessing the hydrogen peroxide content of formulations in which sodium percarbonate was used as a bleach source. The procedure is as follows:
a. In a 100 ml volumetric flask a mixture containing approximately 30 ml deionised water and 5 ml H₂SO₄ (10%) was prepared.
b. The sample was taken from the storage stability test and placed into the mixture
c. The mixture was stirred using a magnetic stirrer until completely dissolved (NOTE: do not seal the flask as CO₂ will be liberated during dissolution).
d. Once completely dissolved The flask was topped up to the 100 ml mark using deionised water. The flask was stoppered and inverted at least 10 times to ensure the solution was properly mixed and was homogenous.
e. Using a pipette a 5 ml sample was withdrawn of this solution and added to a clean conical flask.
f. To this 2.5 ml H₂SO₄ (10% w/w) and 2.5 ml KI solution (20% w/w) was added. A brown colour should appear instantly.
g. This solution was left in a dark cupboard/room for at least 20 minutes.
h. Using a burette this mixture was titrated against a solution of sodium thiosulfsulfate (0.1N) until the solution became completely colourless. (NOTE: adding starch when the titration gets close to the end point can help improve accuracy as this turns any remaining iodine in the solution a blue-black colour making it easier to see)
i. The volume of Sodium Thiosulfate taken to produce a clear solution was recorded.
j. The process was repeated until concordant results were obtained (i.e. results that agree to at least 0.05 ml).
4. Calculation of final storage stability of SPC encapsulates.
   a. An average of the sample masses and titre values for the 2 different samples of the same formulation was taken. The following equations were used to obtain a value for the percentage sodium percarbonate remaining in the solution:

$$\% Active Oxygen = \frac{1.6 * titre value}{Sample Mass}$$

$$\% Sodium Carbonate = \frac{\% Active Oxygen}{0.13}$$

0.2 g of coated sodium percarbonate particles were immersed in commercial liquid laundry product (Vanish Powershots and Ariel Liquid tabs) in small vials (˜2 mL volume) and stored either at room temperature or at 40° C. for the times stated after which the percentage level of remaining hydrogen peroxide (based on the initial levels present) was determined by titration.

Table 3 presents stability data for particles coated with a coating composition comprising butyraldehyde-modified Mowiol 4-98 and SDBS and/or NaOH in NaCl.

Table 4 presents the stability for particles coated with both a wax/amphiphilic layer and a layer comprising modified PVOH and salt.

### Example of Exotherm Control Afforded by Presence of Modified PVOH+Salt Layer Together with Wax/Amphiphilic Co-Polymer Layer

Exotherm Control Coating—Measurement of Exotherm Reduction

A sample of sodium percarbonate particles were produced which were coated with wax/amphiphilic co-polymer as described by the method given above to produce a sodium percarbonate particle having a coating of 18% wax (85%)/AGC2 (15%) and labelled CH1. A portion of these particles was further coated from a feedstock of butyl modified PVOH in salt solution in the manner as described above to give a top coating of 5.0% PVB/NaCl. This sample, for the purposes of evaluating its thermal properties was labelled CH2.

Thermal testing method: Accelerating rate calorimetry (ARC) was used to determine the onset temperature and the magnitude of exothermic activity in pseudo adiabatic conditions. A titanium sample chamber size of 10 mL was used and the determination was carried in air. The Phi factor was taken to be 1.55, start temperature was 30° C., the heat step 5° C. and the wait time 15 minutes. The thermal testing results are shown in Table 5.

From the data in Table 5 it can be seen that the addition of a further layer of butyl modified PVOH+salt (sample CH2) results in an increase of the exotherm onset temperature from 50.6° C. to 71.0° C. and that the calculated SADT (self accelerating decomposition temperature) rises significantly from 35.3° C. to 60.6° C. Therefore it is clear that the presence of the layer of PVB/NaCl has significantly improved the response of the particles to overheating.

Screening—PAP

The prepared PAP materials were screened for their stability in isolation at elevated temperatures and in detergent powder formulations. The activity of the PAP in the core materials was determined before, in order to obtain the assay value, and after incubation via the procedure described below.

For the elevated temperature incubation procedure the PAP samples, 0.2 g, were added to a 5 mL plastic tube and sealed. The tubes were then placed in an incubator at 40° C. for 7 and 35 days and then analysed in triplicate for the PAP levels as described below.

For the in-formulation tests a sample of the prepared PAP-containing cores (0.2 g) were added to a standard formulation, either AATCC 1903 standard detergent powder (obtained from James Heal Ltd) or Asda colour formulation (9.8 g). The samples were mixed thoroughly and stored in an incubator at 32° C. and 60% relative humidity for a period of 7, 28 and 42 days and then removed to evaluation the remaining PAP content via the titration method described below.

In all cases the evaluations were conducted in triplicate whereby multiple samples were stored in the incubators in order for the complete sample to be evaluated following the allotted time interval.

Determination of PAP by Iodometric Titration

A sample of the PAP material, either on its own (0.2 g) or in a powder formulation (sufficient core material to give an equivalent of 0.2 g of 100% active PAP in addition to test powder formulation to give a 10 g sample, for example 0.4 g of a core material with 50% activity in combination with 9.6 g of powder formulation), was dissolved in glacial acetic acid (15 mL) and methanol (50 mL), following this potassium iodide (1 g) was added and solution was stirred at room temperature for 20 minutes. The evolved molecular iodine was titrated with a standard 0.1 N sodium thiosulfate solution until the solution remained colourless and the volume of titrant recorded.

The percentage of PAP in each sample was determined from the following calculations.

$$\% PAP = \frac{C \times F \times 0.1 \times M \times 100}{W \times 1000 \times 2}$$

C=consumption of sodium thiosulfate
F=correction of titrant (0.1 mol/l Na₂S₂O₃)
M=molecular weight of PAP=277.3
W=weight of the sample

$$\% PAP = \frac{C \times F \times 1.386}{W}$$

C=consumption of sodium thiosulfate
F=correction factor of titrant
W=weight of sample [g]

In each case the level of remaining PAP in the sample was compared to the initial assay after particle formation in order to determine the % activity level.

Table 6 shows the test results for PAP stability in washing powder. Eureco MG is a commercially available granulated product containing PAP which is available from Solvay. AATCC is a standard reference washing powder which is available from James Heal (Halifax, UK)

Water Content Analysis:

Water content was determined using a Metrohm 701 KF titrino volumetric Karl Fisher titrator.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

Unless otherwise specified, all references in Tables 1-6 below to “%” mean wt. %.

TABLE 1
Example Feedstock Preparation

| | | |
|---|---|---|
| Material/action | Quantity/g | Temperature |

Spray feedstock preparation

| | | |
|---|---|---|
| NaCl | 56 | Ambient |
| Water | 944 | Ambient |
| PVB solution | 1,000 | Ambient |
| prepared as above | | |
| (Synthesis Example 1) | | |

| | | |
|---|---|---|
| Stir until fully mixed | Ambient | Total Solids ~8% |

TABLE 2
Results-SPC in Laundry Powder

| | | | | Stability in AATCC powder at 32° C./% compared | | | | | |
|---|---|---|---|---|---|---|---|---|---|
| | | | | to original assay | | | | | |
| | | | Coating | 3 days | | 7 days | | 28 days | |
| SPC | | Coated | weight | | Open | | Open | | Open |
| core | | particle | achieved/ | Closed | Vessel | Closed | Vessel | Closed | Vessel |
| used | Coating Composition | ref. | % | Vessel | 60% rh | Vessel | 60% rh | Vessel | 60% rh |
| S131 | Uncoated | PVB A | N/A | n/d | n/d | n/d | n/d | 74.51 | 78.25 |
| Provox C | Uncoated | PVB B | N/A | n/d | n/d | n/d | n/d | 70.42 | 65.05 |
| Provox C | 8% butyrald. Modified Mowiol 10-98 | PVB 1 | 10.1 | 95.39 | 98.55 | 96.76 | 101.31 | 102.09 | 101.21 |
| | (63%): NACl (37%) | | | | | | | | |
| Provox C | 8% butyrald. Modified Mowiol 10-98 | PVB 2 | 3.3 | 89.12 | 90.5 | 91.64 | 91.32 | 100.53 | 96.3 |
| | (63%): NACl (37%) | | | | | | | | |
| Provox C | 8% butyrald. Modified Mowiol 10-98 | PVB 3 | 7.7 | n/d | n/d | 100 | 97.52 | 88.6 | 84.32 |
| | (63%): NACl (37%) | | | | | | | | |
| Provox C | 8% butyrald. Modified Mowiol 10-98 | PVB 4 | 7.0 | n/d | n/d | 101.37 | 101.12 | 93.25 | 87.89 |
| | (63%): NACl (37%) | | | | | | | | |
| Provox C | 8% butyrald. Modified Mowiol 10-98 | PVB 5 | 4.3 | n/d | n/d | n/d | n/d | 96.33 | 90.31 |
| | (63%): NACl (37%) | | | | | | | | |
| Provox C | 8% butyrald. Modified Mowiol 10-98 | PVB 6 | 1.5 | n/d | n/d | n/d | n/d | 92.24 | 84.2 |
| | (63%): NACl (37%) | | | | | | | | |
| Provox C | 8% butyrald. Modified Mowiol 10-98 | PVB 7 | 4.1 | n/d | n/d | n/d | n/d | 101.77 | 93.92 |
| | (63%): NACl (37%) | | | | | | | | |
| Provox C | 8% butyrald. Modified Mowiol 10-98 | PVB 8 | 4.6 | n/d | n/d | n/d | n/d | 99.81 | 93.35 |
| | (83.3%): SDBS (16.7%) | | | | | | | | |
| Provox C | 8% butyrald. Modified Mowiol 10-98 | PVB 9 | 6.1 | n/d | n/d | n/d | n/d | 99.26 | 94.81 |
| | (81.5%): NACl (18.5%) | | | | | | | | |
| S131 | 8% butyrald. Modified Mowiol 10-98 | PVB 10 | 0.5 | n/d | n/d | n/d | n/d | 98.89 | 95.79 |
| | (63%): NACl (37%) | | | | | | | | |
| S131 | 8% butyrald. Modified Mowiol 10-98 | PVB 11 | 3.6 | n/d | n/d | n/d | n/d | 98.5 | 98.87 |
| | (63%): NACl (37%) | | | | | | | | |
| S131 | 8% butyrald. Modified Mowiol 10-98 | PVB 12 | 6.1 | n/d | n/d | n/d | n/d | 97.5 | 97.92 |
| | (63%): NACl (37%) | | | | | | | | |
| S131 | 8% butyrald. Modified Mowiol 10-98 | PVB 13 | 8.7 | n/d | n/d | n/d | n/d | 99.31 | 100.7 |
| | (63%): NACl (37%) | | | | | | | | |
| Provox C | 8% butyrald. Modified Mowiol 10-98 | PVB 14 | 4.5 | n/d | n/d | n/d | n/d | 101.07 | 97.73 |
| | (56%):,. NACl (32.8%): SDBS (11.2%) | | | | | | | | |
| Provox C | 8% butyrald. Modified Mowiol 10-98 | PVB 15 | 8.2 | n/d | n/d | n/d | n/d | 104.13 | 106.67 |
| | (56%):,. NACl (32.8%): SDBS (11.2%) | | | | | | | | |
| S131 | 8% butyrald. Modified Mowiol 10-98 | PVB 16 | 1.6 | n/d | n/d | n/d | n/d | 100.71 | 101.48 |
| | (56%):,. NACl (32.8%): SDBS (11.2%) | | | | | | | | |
| S131 | 8% butyrald. Modified Mowiol 10-98 | PVB 17 | 4.3 | n/d | n/d | n/d | n/d | 102.36 | 104.7 |
| | (56%):,. NACl (32.8%): SDBS (11.2%) | | | | | | | | |
| S131 | 8% butyrald. Modified Mowiol 10-98 | PVB 18 | 7.4 | n/d | n/d | n/d | n/d | 96.99 | 99.6 |
| | (56%):,. NACl (32.8%): SDBS (11.2%) | | | | | | | | |
| S131 | 8% butyrald. Modified Mowiol 10-98 | PVB 19 | 13.4 | n/d | n/d | n/d | n/d | 97.82 | 98.14 |
| | (56%):,. NACl (32.8%): SDBS (11.2%) | | | | | | | | |
| Provox C | 8% butyrald. Modified Mowiol 10-98 | PVB 20 | 3 | n/d | n/d | 83.67 | 87.16 | n/d | n/d |
| | (83.3%): SDBS (16.7%) | | | | | | | | |
| S131 | 8% butyrald. Modified Mowiol 10-98 | PVB 21 | −0.6 | n/d | n/d | 87.5 | 87.61 | n/d | n/d |
| | (83.3%): SDBS (16.7%) | | | | | | | | |
| S131 | 8% butyrald. Modified Mowiol 10-98 | PVB 22 | 2.2 | n/d | n/d | 88.42 | 88.47 | n/d | n/d |
| | (83.3%): SDBS (16.7%) | | | | | | | | |
| Provox C | 8% butyrald. Modified Mowiol 10-98 | PVB 23 | 4.9 | n/d | n/d | 98.62 | 99.49 | n/d | n/d |
| | (63%): NACl (37%) | | | | | | | | |
| S131 | 8% butyrald. Modified Mowiol 10-98 | PVB 24 | 4.2 | n/d | n/d | 101.26 | 98.89 | n/d | n/d |
| | (56%):,. NACl (32.8%): SDBS (11.2%) | | | | | | | | |

Standard test Laundry powder AATCC supplied by James Heal, Halifax, UK
n/d = not determined
n/a = not applicable
Mowiol is the trade name of Kuraray Co. Ltd for PVOH. Similar PVOH grades are available from other manufacturers

TABLE 2a
Results-SPC in Laundry Powder. Use of alternative salts and polymer molecular weight

| | | | | Stability in AATCC powder at 32° C. | |
|---|---|---|---|---|---|
| | | | | compared to original assay | |
| | | | coating | 28 days | |
| SPC | | | weight | Opened | |
| core | | | achieved | vessel | Closed |
| used | Coating composition | Coated particle ref. | (%) | 60% RH | vessel |
| Provox C | Uncoated | PVB B | | 65.05 | 70.42 |
| Provox C | 8% butyrald Modified Mowiol | PVB10MG-1LP | 0.64% | 86.5 | 86.75 |
| | 10-98 (95.4%): MgSO₄ (4.6%) | | | | |
| Provox C | 8% butyrald Modified Mowiol | PVB10MG-2LP | 2.88% | 94.09 | 97.55 |
| | 10-98 (95.4%): MgSO₄ (4.6%) | | | | |
| Provox C | 8% butyrald Modified Mowiol | PVB10MG-3LP | 5.68% | 89.83 | 93.11 |
| | 10-98 (95.4%): MgSO₄ (4.6%) | | | | |
| Provox C | 8% butyrald Modified Mowiol 6-98 | PVB6MG-1LP | 0.60% | 93.68 | 93.11 |
| | (95.4%): MgSO₄ (4.6%) | | | | |
| Provox C | 8% butyrald Modified Mowiol 6-98 | PVB6MG-2LP | 3.10% | 94.39 | 100.4 |
| | (95.4%): MgSO₄ (4.6%) | | | | |
| Provox C | 8% butyrald Modified Mowiol 6-98 | PVB6MG-3LP | 5.90% | 96.25 | 102.5 |
| | (95.4%): MgSO₄ (4.6%) | | | | |
| Provox C | 8% butyrald Modified Mowiol 4-88 | PVB4MG-1LP | 1.00% | 96.01 | 94.76 |
| | (95.4%): MgSO₄ (4.6%) | | | | |
| Provox C | 8% butyrald Modified Mowiol 4-88 | PVB4MG-2LP | 3.10% | 95.12 | 96.12 |
| | (95.4%): MgSO₄ (4.6%) | | | | |
| Provox C | 8% butyrald Modified Mowiol 4-88 | PVB4MG-3LP | 5.40% | 95.39 | 97.38 |
| | (95.4%): MgSO₄ (4.6%) | | | | |
| Provox C | 8% butyrald Modified Mowiol | PVB10SS-1LP | 0.40% | 90.62 | 92.34 |
| | 10-98 (92.3%): MgSO₄ (7.7%) | | | | |
| Provox C | 8% butyrald Modified Mowiol | PVB10SS-2LP | 3.12% | 94.36 | 93.85 |
| | 10-98 (92.3%): MgSO₄ (7.7%) | | | | |
| Provox C | 8% butyrald Modified Mowiol | PVB10SS-3LP | 5.60% | 96.31 | 96.95 |
| | 10-98 (92.3%): MgSO₄ (7.7%) | | | | |
| Provox C | 8% butyrald Modified Mowiol 6-98 | PVB6SS-1LP | 0.68% | 98.55 | 96.82 |
| | (92.3%): MgSO₄ (7.7%) | | | | |
| Provox C | 8% butyrald Modified Mowiol 6-98 | PVB6SS-2LP | 3.08% | 96.05 | 98.59 |
| | (92.3%): MgSO₄ (7.7%) | | | | |
| Provox C | 8% butyrald Modified Mowiol 6-98 | PVB6SS-3LP | 5.39% | 103.27 | 102.32 |
| | (92.3%): MgSO₄ (7.7%) | | | | |
| Provox C | 8% butyrald Modified Mowiol 4-88 | PVB4SS-1LP | 0.70% | 93.15 | 93.19 |
| | (92.3%): MgSO₄ (7.7%) | | | | |
| Provox C | 8% butyrald Modified Mowiol 4-88 | PVB4SS-2LP | 3.10% | 94.81 | 93.62 |
| | (92.3%): MgSO₄ (7.7%) | | | | |
| Provox C | 8% butyrald Modified Mowiol 4-88 | PVB4SS-3LP | 5.20% | 90.38 | 88.7 |
| | (92.3%): MgSO₄ (7.7%) | | | | |

Standard test Laundry powder AATCC supplied by James Heal, Halifax, UK

TABLE 3
SPC in Liquid Laundry Product

| | | | | Stability in Vanish Powershots | | | | | | Stability in Ariel liquid tabs | | | | | |
|---|---|---|---|---|---|---|---|---|---|---|---|---|---|---|---|
| | | | coating | compared to original assay/% | | | | | | compared to original assay/% | | | | | |
| SPC | | Coated | weight | 3 days | | 7 days | | 28 days | | 3 days | | 7 days | | 28 days | |
| core | Coating | particle | achieved/ | | 40° | | 40° | | 40° | | 40° | | 40° | | 40° |
| used | Composition | ref. | % | RT | C. | RT | C. | RT | C. | RT | C. | RT | C. | RT | C. |
| S131 | 5% butyrald. | PVB 25 | 4.6 | n/d | N/D | 89.6 | 55.1 | 71.29 | 8.49 | N/D | N/D | 88.61 | 32.8 | 56.82 | 2.68 |
| | modified | | | | | | | | | | | | | | |
| | Mowiol 4-98 | | | | | | | | | | | | | | |
| | (91%):, SDBS | | | | | | | | | | | | | | |
| | (9%) | | | | | | | | | | | | | | |
| S131 | 5% butyrald. | PVB 26 | 6 | n/d | N/D | 93.34 | 67.74 | 75.87 | 16.61 | N/D | N/D | 91.75 | 50.72 | 70.74 | 4.52 |
| | modified. | | | | | | | | | | | | | | |
| | Mowiol 4-98 | | | | | | | | | | | | | | |
| | (83.3):, SDBS | | | | | | | | | | | | | | |
| | (16.7%) | | | | | | | | | | | | | | |
| S131 | 5% butyrald. | PVB 27 | 5.8 | n/d | N/D | N/D | N/D | 67.68 | 2.5 | N/D | N/D | N/D | N/D | 55.74 | 1.23 |
| | Modified | | | | | | | | | | | | | | |
| | Mowiol 4-98 | | | | | | | | | | | | | | |
| | (58.9%): SDBS | | | | | | | | | | | | | | |
| | (41.1%) | | | | | | | | | | | | | | |
| S131 | 5% butyrald. | PVB 28 | 8 | n/d | n/d | n/d | n/d | 55.12 | 1.17 | n/d | n/d | n/d | n/d | 61.6 | 1.37 |
| | Modified | | | | | | | | | | | | | | |
| | Mowiol 4-98 | | | | | | | | | | | | | | |
| | (50%): SDBS | | | | | | | | | | | | | | |
| | (50%) | | | | | | | | | | | | | | |
| Provox | 8% Butyrald | PVB 29 | 8.7 | n/d | n/d | 94.63 | 49.14 | n/d | n/d | n/d | n/d | 96.64 | 39.34 | n/d | n/d |
| C | modified | | | | | | | | | | | | | | |
| | Mowiol 10-98 | | | | | | | | | | | | | | |
| | (63%): NACl | | | | | | | | | | | | | | |
| | (37%) | | | | | | | | | | | | | | |
| S131 | 8% Butyrald | PVB 30 | 7.3 | n/d | n/d | n/d | n/d | n/d | n/d | n/d | n/d | 93.05 | 25.2 | n/d | n/d |
| | modified | | | | | | | | | | | | | | |
| | Mowiol 10-98 | | | | | | | | | | | | | | |
| | (63%): NACl | | | | | | | | | | | | | | |
| | (37%) | | | | | | | | | | | | | | |

n/d = not determined

TABLE 3A
SPC in Liquid Laundry Product. Use of alternative salts, polymer molecular weights

| | | | | | Stability results compared with original | | | |
|---|---|---|---|---|---|---|---|---|
| | | | | | assay (%) | | | |
| | | | | | | | stability in 3in1 | |
| | | | | | stability in 3in1 Ariel | | Ariel POD + 13% | |
| | | | Coated SPC | coating | POD | | GLDA | |
| | | Coating type & | reference | thickness | 28 days | | 28 days | |
| DATA SET | SPC Core | composition | number | (%) | RT | 32° C. | RT | 32° C. |
| uncoated SPC | Oxyper SCM | Uncoated SCM | Uncoated SCM | 0 | 38.8 | 12.6 | 59.5 | 19.3 |
| | Q35 | Q35 | Uncoated Q35 | 0 | 37.7 | 17.5 | | |
| Different | Q35 | 8% butyrald modified | PVB10-04SS-1LL | 17.7 | 80.6 | 39.9 | | |
| molarity | | Mowiol 10-98 | | | | | | |
| of salt | | (90.15%): Na₂SO₄ | | | | | | |
| in the PVB | | (9.85%) | | | | | | |
| coating | Oxyper SCM | 8% butyrald modified | PVB10-08SS-1LL | 17.3 | 77.3 | 59.9 | 91.7 | 71.4 |
| | | Mowiol 10-98 (82%): | | | | | | |
| | | (18%)Na₂SO₄ | | | | | | |
| | Oxyper SCM | 8% butyrald modified | PVB10-01SS-1LL | 16.7 | 81.1 | 64.5 | 96.4 | 77.4 |
| | | Mowiol 10-98 (78%): | | | | | | |
| | | Na₂SO₄ (22%) | | | | | | |
| | Oxyper SCM | 8% butyrald modified | PVB10-15SS-1LL | 15.6 | 41.5 | 7.7 | 90.2 | 32.2 |
| | | Mowiol 10-98 (70%): | | | | | | |
| | | Na₂SO₄ (30%) | | | | | | |
| Different | Oxyper SCM | 8% butyrald modified | PVB10-08SS-2LL | 26.4 | 91.7 | 79.1 | 104.4 | 89.7 |
| coating levels | | Mowiol 10-98 (82%): | | | | | | |
| | | (18%)Na₂SO₄ | | | | | | |
| | Oxyper SCM | 8% butyrald modified | PVB10-08SS-1LL | 17.3 | 77.3 | 59.9 | 91.7 | 71.4 |
| | | Mowiol 10-98 (82%): | | | | | | |
| | | (18%)Na₂SO₄ | | | | | | |
| | Oxyper SCM | 8% butyrald modified | PVB10-08SS-4LL | 13.6 | 79.0 | 65.1 | 83.1 | 78.6 |
| | | Mowiol 10-98 (82%): | | | | | | |
| | | (18%)Na₂SO₄ | | | | | | |
| | Oxyper SCM | 8% butyrald modified | PVB10-08SS-5LL | 9.3 | 72.2 | 35.6 | 84.9 | 45.8 |
| | | Mowiol 10-98 (82%): | | | | | | |
| | | (18%)Na₂SO₄ | | | | | | |
| Different | Oxyper SCM | 8% butyrald modified | PVB10-08SS-1LL | 17.3 | 77.3 | 59.9 | 91.7 | 71.4 |
| types | | Mowiol 10-98 (82%): | | | | | | |
| of PVB | | (18%)Na₂SO₄ | | | | | | |
| | Oxyper SCM | 8% butyrald modified | PVB6-08SS1LL | 17.5 | 74.6 | 46.8 | 93.0 | 71.5 |
| | | Mowiol 6-98(82%): | | | | | | |
| | | (18%) Na₂SO₄ | | | | | | |
| | Oxyper SCM | 8% butyrald modified | PVB4-08SS1LL | 18.4 | 86.6 | 63.1 | 99.8 | 67.7 |
| | | Mowiol 4-98(82%): | | | | | | |
| | | (18%)Na₂SO₄ | | | | | | |
| | Oxyper SCM | 8% butyrald modified | PVB3-08SS1LL | 18.5 | 32.4 | 3.1 | 80.4 | 31.8 |
| | | Mowiol 3-98 (82%): | | | | | | |
| | | (18%)Na₂SO₄ | | | | | | |
| | Oxyper SCM | 8% butyrald modified | PVB8-04SS1LL | 16.3 | 32.8 | 2.3 | 75.5 | 27.6 |
| | | Mowiol 8-88 (90.15%): | | | | | | |
| | | (9.85) Na₂SO₄ | | | | | | |
| | Oxyper SCM | 8% butyrald modified | PVB688-04SS1LL | 16.5 | 36.6 | 11.4 | 80.6 | 34.0 |
| | | Mowiol 6-88 (90.15%): | | | | | | |
| | | (9.85) Na₂SO₄ | | | | | | |
| | Oxyper SCM | 8% butyrald modified | PVB488-08SS1LL | 18 | 74.4 | 32.2 | 90.2 | |
| | | Mowiol 4-88 (82%): | | | | | | |
| | | (18%)Na₂SO₄ | | | | | | |
| | Oxyper SCM | 8% butyrald modified | PVB385-04SS1LL | 18.1 | 52.9 | 24.2 | 89.0 | 58.6 |
| | | Mowiol 3-85 (90.15%): | | | | | | |
| | | (9.85) Na₂SO₄ | | | | | | |
| Different | Oxyper SCM | 8% butyrald modified | PVB10-08SS-1LL | 17.3 | 77.3 | 59.9 | 91.7 | 71.4 |
| types | | Mowiol 10-98 (82%): | | | | | | |
| of salts in | | (18%)Na₂SO₄ | | | | | | |
| PVB coating | Oxyper SCM | 8% butyrald modified | PVB10-005MB-1LL | 8.3 | 51.3 | 30.9 | 90.9 | 54.3 |
| | | Mowiol 10-98 (99.1%): | | | | | | |
| | | (0.9%) BNa₂O₂ | | | | | | |
| | Oxyper SCM | 8% butyrald modified | PVB10-0025MB-1LL | 3.8 | 38.5 | 9.8 | 77.8 | 33.9 |
| | | Mowiol 10-98 (99.55%): | | | | | | |
| | | (0.45%) BNa₂O₂ | | | | | | |
| | Oxyper SCM | 8% butyrald modified | PVB10-05SC-1LL | 17.3 | 82.5 | 67.3 | 91.8 | 74.5 |
| | | Mowiol 10-98 (90%): | | | | | | |
| | | (10%) Na₂CO₃ | | | | | | |

TABLE 3B
SPC in Commercial Liquid Dish Wash Product. Use of surfactant and polymer molecular weights

| | | | | | | | Modified Sun | |
|---|---|---|---|---|---|---|---|---|
| | | | | coating | | | all in One | |
| | | | Coated SPC | thick- | Sun all in One | | (+15% GLDA) | |
| | | | reference | ness- | 28 days | | 28 days | |
| DATA SET | SPC Core | Coating type & composition | number | (%) | RT | 32° C. | RT | 32° C. |
| uncoated SPC | Oxyper S131 | uncoated S131 | S131 | | 1.22 | 1.18 | 19.03 | 1.14 |
| | Oxyper SCM | uncoated SCM | SCM | 0 | 1.22 | 1.18 | 7.54 | 1.27 |
| sdbs level | S131 | 8% butyrald modified Mowiol 10-98 (80%): | PVB10-20SD1 | 11.4 | 8.94 | 1.35 | | |
| | | (20%) SDBS | | | | | | |
| | S131 | 8% butyrald modified Mowiol 10-98 (83.3%): | PVB10-167SD1 | 11.4 | 87.43 | 54.27 | | |
| | | (16.7%) SDBS | | | | | | |
| | S131 | 8% butyrald modified Mowiol 10-98 (90%): | PVB10-10SD1 | 10.6 | 62.33 | 6.27 | | |
| | | (10%) SDBS | | | | | | |
| | S131 | 8% butyrald modified Mowiol 10-98 (95%): | PVB105SD1 | 10.8 | 71.9 | 17.8 | | |
| | | (5%) SDBS | | | | | | |
| coat wt | S131 | 8% butyrald modified Mowiol 10-98 (83.3%): | PVB10-167SD2 | 18.96 | 76.59 | 16.72 | 93.5 | 77.76 |
| | | (16.7%) SDBS | | | | | | |
| | S131 | 8% butyrald modified Mowiol 10-98 (83.3%): | PVB10-167SD3 | 9 | 63.84 | 16.71 | 87.94 | 72.52 |
| | | (16.7%) SDBS | | | | | | |
| | S131 | 8% butyrald modified Mowiol 10-98 (83.3%): | PVB10-167SD4 | 5.2 | 48.9 | 6.32 | 79.41 | 34.42 |
| | | (16.7%) SDBS | | | | | | |
| scm | SCM | 8% butyrald modified Mowiol 10-98 (83.3%): | PVB10-167SD5 | 8.9 | 37.99 | 5.39 | 74.54 | 41.07 |
| | | (16.7%) SDBS | | | | | | |
| | SCM | 8% butyrald modified Mowiol 6-98 (83.3%): | PVB6-167SD1 | 9.9 | | | | |
| | | (16.7%) SDBS | | | | | | |
| | SCM | 8% butyrald modified Mowiol 4-98 (83.3%): | PVB4-167SD1 | 9.1 | 49.69 | 4.48 | 95.62 | 82.74 |
| | | (16.7%) SDBS | | | | | | |
| | SCM | 8% butyrald modified Mowiol 3-98 (83.3%): | PVB3-167SD1 | 10 | | | | |
| | | (16.7%) SDBS | | | | | | |
| | SCM | 8% butyrald modified Mowiol 8-88 (83.3%): | PVB8-167SD1 | 9.8 | | | | |
| | | (16.7%) SDBS | | | | | | |
| | SCM | 8% butyrald modified Mowiol 6-88 (83.3%): | PVB688-167SD1 | 8.8 | 17.07 | 2.89 | 66.26 | 8.79 |
| | | (16.7%) SDBS | | | | | | |
| | S131 | 8% butyrald modified Mowiol 10-98 (82%): | PVB10-08SSF | 9.7 | 73.1 | 21.46 | | |
| | | (18%)Na2SO₄ | | | | | | |

TABLE 4
Composition of SPC sample coated both with wax/amphiphilic layer and a layer comprising modified PVOH + salt

| | | | Coating | | | | | | | | | |
|---|---|---|---|---|---|---|---|---|---|---|---|---|
| | | Coating | level | Stability in Vanish | | | | | | | | |
| | coated | level | PVB(63%)/ | Powershots compared to | | | Stability in Ariel liquid tabs compared to | | | | | |
| | SPC | Wax(85%)/ | NACl | original assay/% | | | original assay/% | | | | | |
| Coating type & | reference | AGC2(15%) | (37%) | 28 days | | | 7 days | | | 28 days | | |
| composition | number | (%) | (%) | RT | 30° C. | 40° C. | RT | 30° C. | 40° C. | RT | 30° C. | 40° C. |
| S131 core. 8% | PVB 31 | 13.0 | 5.0 | 66.37 | n/d | 45.53 | 92.74 | n/d | 61.51 | 55.35 | n/d | 13.67 |
| butyraldehyde | | | | | | | | | | | | |
| modified Mowiol | | | | | | | | | | | | |
| 10-98 (63%): | | | | | | | | | | | | |
| NACl (37%) on | | | | | | | | | | | | |
| top of | | | | | | | | | | | | |
| wax(85%)/ | | | | | | | | | | | | |
| AGC2(15%) | | | | | | | | | | | | |
| S131 core. 8% | PVB 32 | 14.5 | 4.4 | 60.72 | n/d | 9.82 | 90.71 | n/d | 56.48 | 63.64 | n/d | 1.55 |
| butyraldehyde | | | | | | | | | | | | |
| modified Mowiol | | | | | | | | | | | | |
| 10-98 (63%): | | | | | | | | | | | | |
| NACl (37%) on | | | | | | | | | | | | |
| top of wax(85%)/ | | | | | | | | | | | | |
| AGC2(15%) | | | | | | | | | | | | |

TABLE 5
Thermal testing: results

| Test Results | CH1 | CH2 |
|---|---|---|
| Exotherm onset temperature (° C.) | 50.6 | 71.0 |
| Peak temperature of exotherm (° C.) | 251.7 | 262.2 |
| Peak pressure of exotherm (barg) | 72.9 | 84.9 |
| Maximum rate of temperature rise (K · min−1) | 892.5 | 711.0 |
| Maximum rate of pressure rise (bar · min−1) | 835.2 | 2072.1 |
| Gas generation onset temperature (° C.) | 108.1 | 108.6 |
| Quantity of gas generated (cm³ · g−1 at STP) | ≧9.2 | ≧4.2 |
| Estimated SADT for 50 kg package (° C.) | 35.3 | 60.6 |

TABLE 6
Test Results-PAP stability in washing powder

| | | | | | | PAP stability coated | | |
|---|---|---|---|---|---|---|---|---|
| | Description of the core | | Description of the coated particle | | | samples/% | | |
| Washing | Core | | Coated | | | Washing powder- | | |
| powder | particle | | PAP | | Coating | (32° C., 60% RH.) | | |
| used | reference | Description of the core (PAP core | reference | Coating type & | thickness/ | 7 | 28 | 42 |
| in test | number | particle) | number | composition | % | days | days | days |
| ASDA | — | Eureco MG | — | Uncoated | — | 65.12 | 37.5 | 15.7 |
| brand | | | | | | | | |
| colour | | | | | | | | |
| powder | | | | | | | | |
| AATCC | — | Eureco MG | — | Uncoated | — | 89.86 | 73.57 | 62.48 |
| reference | | | | | | | | |
| powder | | | | | | | | |
| AATCC | PAP 1 | PAP (Eureco WM1) + Potato Starch (7%) + | PAP 1-C1 | 5% butyrald. modified | 3.8 | 88.63 | 70.36 | 70.86 |
| reference | | Hostapur 3:5 (8%) + Citric Acid (2.7%) + | | Mowiol 4-98 (91%):, | | | | |
| powder | | HEDP (1%) | | SDBS (9%) | | | | |
| AATCC | PAP1 | PAP (Eureco WM1) + Potato Starch (7%) + | PAP1-C2 | 5% butyrald. modified. | 3.4 | 88.21 | 70.2 | 72.4 |
| reference | | Hostapur 3:5 (8%) + Citric Acid (2.7%) + | | Mowiol 4-98 (83.3):, | | | | |
| powder | | HEDP (1%) | | SDBS (16.7%) | | | | |

1. A composite comprising at least one benefit agent, and a blend comprising:
(i) a water-soluble polymer being a poly(vinyl alcohol) polymer modified by reaction with a 2-10C aldehyde, such that 1-15% of the available —OH groups have been modified;
(ii) at least one ionic species;
(iii) optionally at least one wax or wax-like substance; and
(iv) optionally at least one amphiphilic polymer.

2. The composite of claim 1, wherein the composite is in the form of a matrix particle.

3. The composite of claim 1, wherein the blend constitutes between 0.1 and 50 wt % of the total weight of the composite

4. The composite of claim 1, wherein the blend constitutes between 0.1 and 30 wt % of the total weight of the composite.

5. The composite of claim 1, wherein the blend constitutes between 4 and 15 wt % of the total weight of the composite.

6. The composite of claim 1, wherein the water-soluble polymer is a poly(vinyl alcohol) polymer modified by reaction with at least one 2-6C aldehyde.

7. The composite of claim 1, wherein the water-soluble polymer is a poly(vinyl alcohol) polymer modified by reaction with butyraldehyde.

8. The composite of claim 1, wherein 2-12% of the available —OH groups of the poly(vinyl alcohol) have been modified.

9. The composite of claim 1, wherein 4-10% of the available —OH groups of the poly(vinyl alcohol) have been modified.

10. The composite of claim 1, wherein the ionic species is a salt or an ionic surfactant.

11. The composite of claim 1, wherein the ionic species constitutes between 5 and 55% of the total weight of the blend.

12. The composite claim 1, wherein the ionic species constitutes between 30 and 55% of the total weight of the blend.

13. The composite of claim 1, wherein the ionic species is selected from one or more of:
i) chloride, sulphate and carbonate salts of the alkaline metals or alkaline earth metals; and
ii) surfactants represented by the general formula RSO₃M wherein R represents a hydrocarbon group selected from the group consisting of straight or branched alkyl radicals containing from about 8 to about 24 carbon atoms and alkyl phenyl radicals containing from about 9 to about 15 carbon atoms the alkyl group; and M is a cation which typically is selected from the group consisting of sodium, potassium, ammonium, monoalkanolammonium, dialkanolammonium, trialkanolammonium, and magnesium cations and mixtures thereof.

14. The composite of claim 1, wherein the ionic species is selected from one or more of NaCl, Na₂CO₃, Na₂SO₄, MgSO₄ and sodium dodecyl benzene sulfonate (SDBS).

15. The composite of claim 1 wherein the benefit agent is selected from a bleach, a bleach activating agent, a preformed peracid, a bleach booster, a diacyl peroxide, a hydrogen peroxide source, a metal catalyst or pro-catalyst, an enzyme, a drug, a pro-drug, a vitamin, a pro-vitamin, an essential oil, a fish oil, a lubricant, a flavour and a fragrance.

16. A process for preparing a composite as claimed in claim 1, said process comprising the steps of:
(1) preparing one or more core units comprising at least one benefit agent;
(2) preparing a coating layer (B) comprising a blend comprising:
(i) a water-soluble polymer being a poly(vinyl alcohol) polymer modified by reaction with a 2-10C aldehyde, such that 1-15% of the available —OH groups have been modified; and
(ii) at least one ionic species;
(3) optionally preparing a further coating layer (C) comprising a blend comprising:
(i) at least one wax or wax-like substance; and
(ii) at least one amphiphilic polymer;
(4) applying coating layer (B) and optionally applying coating layer (C) to the core units to form a composite; and
(5) drying the resulting particles to yield the composite.

17. A consumer product comprising a composite according to claim 1.

18. The consumer product of claim 17, wherein the product is selected from laundry products, dishwash products, personal care and cosmetic formulations, surface cleaning formulations, pharmaceutical, veterinary, food, vitamin, mineral and nutritional compositions.

19. The consumer product of claim 17, wherein the product is a liquid laundry product.

20. A composite according to claim 1 is applied in the preparation of a consumer product.

21. A method of preparing a laundry product, said method comprising admixing a composite according to claim 1 with one or more conventional laundry product components.

22. A process for preparing a blend comprising:
(i) a water-soluble polymer being a poly(vinyl alcohol) polymer modified by reaction with a 2-10C aldehyde, such that 1-15% of the available —OH groups have been modified; and
(ii) at least one ionic species
as a phlegmatizer.

23. A process for preparing a blend comprising:
(i) a water-soluble polymer being a poly(vinyl alcohol) polymer modified by reaction with a 2-10C aldehyde, such that 1-15% of the available —OH groups have been modified; and
(ii) at least one ionic species
to stabilise or desensitise a benefit agent against undesired overheating.
